(19) United States
(12) Patent Application Publication
(10) Pub. No.: US 2019/0172362 A1
(43) Pub. Date: Jun. 6, 2019

(54) ELEMENTARY EDUCATION LEARNING SYSTEM

(71) Applicant: DANIELLE C. ERRIGO, Roy, UT (US)

(72) Inventor: DANIELLE C. ERRIGO, Roy, UT (US)

(21) Appl. No.: 16/211,197

(22) Filed: Dec. 5, 2018

Related U.S. Application Data
(60) Provisional application No. 62/594,988, filed on Dec. 5, 2017.

(51) Int. Cl. G09B 1/02; G09B 19/00; G09B 17/00; G09B 19/08; A41B 11/00; A63F 9/00; G09B 19/22; B65D 25/04; B65D 25/54

(52) U.S. Cl. CPC G09B 1/02; G09B 19/0023; G09B 17/00; G09B 19/08; G09B 19/0061; G09B 19/0046; A63F 2009/0049; A41B 11/001; A41B 11/008; A63F 9/001; G09B 19/22; B65D 25/04; B65D 25/54; G09B 19/00

(57) ABSTRACT

An apparatus for educating children includes a sock with an open end and a closed end. The apparatus includes a first sock symbol located on the first side of the sock which is oriented with a top of the first sock symbol oriented toward the closed end of the sock. The apparatus includes a second sock symbol located on the second side of the sock toward the closed end which is oriented with a bottom of the second sock symbol toward the closed end of the sock. Bending an end of the sock toward the first side inverts the second sock symbol and places it and a portion of the second side in a position to be viewed from the first side of the sock. The first and second sock symbols differ. The first and the second sock symbols are related to a same sock topic.

### BACKGROUND OF THE INVENTION

### Field

This invention relates to educational games and activities, and more particularly to elementary education learning system apparatuses and methods.

### Background

The work of doing laundry is a never-ending task that can take a large amount of time and may be quite tedious. The task of matching sets of clothing, and in particular pairs of socks, illustrates one task of laundry that is time consuming and can sometimes be boring. Various methods have been proposed for assisting in the pairing of matching socks, including marking an identical sign on each sock (e.g., “Tommy's black socks”) for matching purposes. Other methods include putting a set of identical decals on the socks or simply matching them the old-fashioned way, by size, shape, texture, pattern, and color. Other prior art apparatuses include marking the socks with their particular color (marking a blue sock with the word “blue,” for example) for teaching color to children or to assist people who are color-blind.

What prior art apparatuses and methods have failed to recognize is that the problem of matching socks brings with it a teaching opportunity, regarding both how to match socks as well as teach and reinforce other types of knowledge, including telling time, languages, geography, reading, mathematics, and just about any other field of knowledge.

### BRIEF SUMMARY

An apparatus for educating children includes a sock with an open end and a closed end distal to the open end and a first side and a second side opposite the first side. The first side and the second side are disposed between the open end and the closed end. The apparatus includes a first sock symbol with a top and a bottom where the first sock symbol is located on the first side of the sock and is oriented with the top of the first sock symbol oriented toward the closed end of the sock. The apparatus includes a second sock symbol with a top and a bottom where the second sock symbol is located on the second side of the sock toward the closed end of the sock and is oriented with the bottom of the second sock symbol toward the closed end of the sock. Bending an end of the sock toward the first side at a location below the second sock symbol inverts the second sock symbol and places the second sock symbol and a portion of the second side in a position to be viewed from the first side of the sock. The first sock symbol differs from the second sock symbol and the first sock symbol and the second sock symbol are related to a same sock topic.

In some embodiments, the sock is a first sock and the apparatus includes a second sock with an open end and a closed end distal to the open end, and a first side and a second side opposite the first side. The first side and the second side are disposed between the open end and the closed end. In the embodiment, the apparatus includes a third sock symbol with a top and a bottom and the third sock symbol is located on the first side of the second sock and is oriented with the top of the third sock symbol oriented toward the closed end of the second sock. In the embodiment, the apparatus includes a fourth sock symbol with a top and a bottom and the fourth sock symbol is located on the second side of the second sock toward the closed end of the second sock and is oriented with the bottom of the fourth sock symbol toward the closed end of the second sock. Bending an end of the second sock toward the first side at a location below the fourth sock symbol inverts the fourth sock symbol and places the fourth sock symbol and a portion of the second side in a position to be viewed from the first side of the second sock. The third sock symbol differs from the fourth sock symbol and the third sock symbol and the fourth sock symbol are related to a same sock topic. One or more of the first and second sock symbols of the first sock are related to one or more of the third and fourth sock symbols of the second sock through a same sock pair topic.

In other embodiments, The first sock symbol, the second sock symbol, the third sock symbol and the fourth sock symbol include an alphanumeric character, a word, punctuation, a mathematical symbol, a mathematical equation, a shape, a color and/or text. In other embodiments, the same sock topic common to the first sock symbol and the second sock symbol, the same sock topic common to the third sock symbol and the fourth sock symbol and the same sock pair topic related to the first and second sock symbols of the first sock and the third and fourth sock symbols of the second sock include one or more of a mathematical topic, a phonetic topic, a language learning topic, a foreign language learning topic, a geography topic, a sign language topic, a geometric topic, a history topic, a science topic and a literary topic.

In other embodiments, the apparatus includes a plurality of pairs of socks, where each pair of socks of the plurality of pairs of socks includes a first sock with first and second sock symbols and a second sock with third and fourth sock symbols. The same sock topics and the same sock pair topics of each pair of socks differs from the same sock topics and same sock pair topic of other pairs of socks in the plurality of pairs of socks. In other embodiments, the plurality of pairs of socks form a sock matching game, where each pair of socks has a unique same sock pair topic and a user matches a first sock with a second sock of a pair of socks of the plurality of pairs of socks according to the same sock pair topic of the pair of socks, and the user matches each of the plurality of pairs of socks of the plurality of pairs of socks based on the same sock pair topic of the plurality of pairs of socks.

In some embodiments, the first side of the sock includes one or more additional sock symbols in addition to the first sock symbol, where the additional sock symbols are related the first sock symbol by a same side sock topic. In other embodiments, the second side of the sock includes one or more additional sock symbols in addition to the second sock symbol, where the additional sock symbols are related the second sock symbol by a same side sock topic. In other embodiments, the sock forms a sock puppet, where a hand of a user inserted into the sock with a palm of the hand facing the first side of the sock bends the fingers of the user's hand to fold the second sock symbol over to be visible on the first side of the sock. In other embodiments, the first sock symbol, the second sock symbol, and/or any additional sock symbols include a non-skid material.

In some embodiments, the first sock symbol, the second sock symbol, and/or any additional sock symbols include at least one of an image printed on the sock, an iron-on transfer applied to the sock and a clothing patch applied to the sock. In other embodiments, bending an end of the sock toward the first side covers the first sock symbol and any additional sock symbols on the first side of the sock and exposes the second sock symbol in a same orientation as the first sock symbol. In other embodiments, the first side includes the first sock symbol and two additional sock symbols below the first sock symbol toward the open end and oriented the same as the first sock symbol and/or the second side includes two additional symbols below the second sock symbol toward the open end and oriented the same as the second sock symbol. Bending the closed end to insert into the open end exposes one sock symbol on one side of the folded sock and two symbols on the other side of the folded sock, which are adjacent to where the closed end is tucked into the open end. In other embodiments, the apparatus includes additional socks. Each sock includes sock symbols and the apparatus includes a box configured with a divider forming two compartments in the box. Each compartment is sized with a length to accommodate a sock without folding the sock and a depth to accommodate a plurality of stacked socks and each compartment is sized to accommodate a plurality of socks folded with the closed end of the sock tucked into the open end of the sock.

A memory game apparatus for educating children includes a first sock and a second sock. Each sock includes an open end and a closed end distal to the open end, and a first side and a second side opposite the first side. The apparatus includes a first sock symbol located on the first side of the first sock and oriented with a top of the first sock symbol oriented toward the closed end of the first sock. The apparatus includes a second sock symbol located on the second side of the first sock toward the closed end of the first sock and oriented with a bottom of the second sock symbol toward the closed end of the first sock. The apparatus includes a third sock symbol located on the first side of the second sock and oriented with a top of the third sock symbol oriented toward the closed end of the second sock and a fourth sock symbol located on the second side of the second sock toward the closed end of the second sock and oriented with a bottom of the fourth sock symbol toward the closed end of the second sock. Bending an end of the first sock toward the first side at a location below the second sock symbol inverts the second sock symbol and places the second sock symbol and a portion of the second side in a position to be viewed from the first side of the first sock. Bending an end of the second sock toward the first side at a location below the fourth sock symbol inverts the fourth sock symbol and places the fourth sock symbol and a portion of the second side in a position to be viewed from the first side of the second sock. The first sock symbol differs from the second sock symbol and the first sock symbol and the second sock symbol are related to a same sock topic. The third sock symbol differs from the fourth sock symbol and the third sock symbol and the fourth sock symbol are related to a same sock topic. One or more of the first and second sock symbols of the first sock are related to one or more of the third and fourth sock symbols of the second sock through a same sock pair topic.

In some embodiments, one or more of the first sock and the second sock include one or more additional sock symbols, where the additional sock symbols are related to a sock topic. In other embodiments, each sock side includes three sock symbols spaced apart from the closed end to the open end and the sock symbols on the first side of a sock are each oriented with a top of the sock symbol toward the closed end of the sock and the sock symbols of the second side of the sock are each oriented with a bottom toward the closed end of the sock. In further embodiments, bending the first sock exposes the second sock symbol while covering at least one of the sock symbols of the first side of the first sock. The second sock symbol is oriented in a same orientation as the sock symbols on the first side of the first sock. Bending the second sock exposes the fourth sock symbol while covering at least one of the sock symbols of the first side of the second sock. The fourth sock symbol is oriented in a same orientation as the sock symbols on the first side of the second sock.

An apparatus for educating children includes a first sock and a second sock. Each sock includes an open end, a closed end distal to the open end, a first side and a second side opposite the first side. The apparatus includes a first sock symbol located on the first side of the first sock and oriented with a top of the first sock symbol oriented toward the closed end of the first sock, and a second sock symbol located on the second side of the first sock toward the closed end of the first sock and oriented with a bottom of the second sock symbol toward the closed end of the first sock. The apparatus includes a third sock symbol located on the first side of the second sock and oriented with a top of the third sock symbol oriented toward the closed end of the second sock, and a fourth sock symbol located on the second side of the second sock toward the closed end of the second sock and oriented with a bottom of the fourth sock symbol toward the closed end of the second sock. The apparatus includes a fifth sock symbol and a sixth sock symbol each located above or below the first sock symbol, and a seventh sock symbol and an eighth sock symbol each located above or below the second sock symbol. The apparatus includes a ninth sock symbol and a tenth sock symbol each located above or below the third sock symbol, and an eleventh sock symbol and a twelfth sock symbol each located above or below the fourth sock symbol. The sock symbols on a side are stacked vertically.

In some embodiments, each sock symbol on the first side of the first and second socks are oriented with a top toward the closed end and each sock symbol on the second side of the first and second socks are oriented with a bottom toward the closed end, where each of the sock symbols are different, at least one sock symbol on a first side of the first sock and at least one sock symbol on the second side of the first sock are related to a same sock topic, at least one sock symbol on a first side of the second sock and at least one sock symbol on the second side of the second sock are related to a same sock topic and at least one sock symbol on the first sock and a sock symbol on the second sock are related to a sock pair topic.

### BRIEF DESCRIPTION OF THE DRAWINGS

In order that the advantages of the invention will be readily understood, a more particular description of the invention will be rendered by reference to specific embodiments illustrated in the appended drawings, which depict only typical embodiments of the invention and are not to be considered limiting of its scope, in which:

FIG. 1 is a schematic view of an embodiment of a pair of socks on which are disposed corresponding and matching symbols;

FIG. 2 is a schematic view of one embodiment of a pair of decals having symbols for application to clothing;

FIG. 3 is another schematic view of a pair of decals having symbols for application to clothing;

FIG. 4 is a schematic view of one embodiment of several decals on a single sheet;

FIG. 5 is another embodiment of a pair of socks on which are disposed associated symbols;

FIG. 6 is a top plan view of another embodiment illustrating a pair of socks on which are disposed associated symbols;

FIG. 7 is a schematic view of a plurality of socks, illustrating an embodiment of a method of choosing matching socks according to the present invention;

FIG. 8 is a schematic flow chart diagram illustrating a method of choosing matching socks;

FIG. 9A is a schematic view of a first side of a sock on which is disposed a symbol;

FIG. 9B is schematic view of a second side of a sock on which is disposed facial features;

FIG. 10 is a schematic view of one embodiment of a pair of socks on which are disposed corresponding and matching symbols and facial features;

FIG. 11A is a schematic view of a first side of a sock on which is disposed a symbol;

FIG. 11B is a schematic view of a second side of a sock on which is disposed facial features;

FIG. 12A is a schematic view of a first side of a sock on which is disposed a symbol prior to folding;

FIG. 12B depicts the folding functionality of the embodiment shown in FIGS. 11A and 11B.

FIG. 13A depicts a side view of the same embodiment depicted in FIGS. 11A and 11B and the same folding functionality depicted in FIG. 12A prior to folding.

FIG. 13B depicts a side view of the same embodiment depicted in FIGS. 11A and 11B and the same folding functionality depicted in FIG. 12B after folding.

FIG. 14 is a schematic view of a pair of decals having symbols and facial features for application to clothing;

FIG. 15 is a schematic view of one embodiment of several decals having symbols and facial features on a single sheet;

FIG. 16 depicts an embodiment of an apparatus for educating children;

FIG. 17 depicts an embodiment of a second apparatus for an elementary education learning system;

FIG. 18 depicts one pair of socks in a third embodiment of an elementary education learning system;

FIG. 19 depicts one pair of socks in a fourth embodiment of an elementary education learning system;

FIG. 20 depicts one pair of socks in a fifth embodiment of an elementary education learning system;

FIG. 21 depicts an embodiment similar to that of FIG. 16, but provides additional views depicting the bending or folding functionality discussed above;

FIG. 22 depicts a schematic view of a first side and a second side of a pair of socks where the socks have sock symbols;

FIG. 23 depicts a schematic view of the socks of FIG. 22 with a top folded over;

FIG. 24 depicts a schematic view of the socks of FIG. 22 with the socks inverted prior to folding;

FIG. 25 depicts a schematic view of the socks of FIG. 22 with the closed end of the socks folded into the open end of the socks;

FIG. 26 depicts a schematic view of the first sock of FIG. 22 with a top folded over and with the top folded back up; and

FIG. 27 depicts a schematic view of a display box with socks laid out lengthwise on one side and with folded socks in the other side.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention provides an educational game for children when matching sets of clothing. According to one embodiment, corresponding and matching symbols may be applied to different items in a set of clothing. The symbols may have a relationship that is educational to a child. A child understanding the relationship can then match the clothing accordingly. The educational relationship may embody various concepts. For example, the relationship may include a mathematical relationship which must be understood in order to match the symbols. As an example of symbols having a mathematical relationship, one symbol on one item in the set of clothing may have the characters “2+2=” while a symbol on another item of clothing in the same set has the character “4.”

Additionally, the type of clothing sets which may be used may also vary and/or include all types of clothing sets. These clothing sets could include a pair of socks, a pair of stockings, a pair of gloves, or any other set of clothing that are meant to be worn together. Other sets of clothing that are meant to be worn together may include one or more shirts, pants, or hats. For example, a clothing set may include one shirt and one pair of pants that are meant to be worn together. In another example, a clothing set may include a pair of gloves.

As mentioned above, one embodiment of the present invention includes symbols disposed on socks. In one exemplary embodiment, several pairs of socks have matching symbols on each sock in a pair, the symbol on each sock of the pair matching a symbol of the other sock of the pair. After socks have been laundered, socks are usually matched into pairs. Thus, after the several pairs of socks have been laundered a child can take part in an educational game of matching socks. A child may compare symbols on socks to determine which sock matches a given sock, teaching and/or reinforcing principles of an educational topic. Thus, helping with laundry becomes a fun and intellectually challenging game for a child.

To emphasize the benefits of the present invention and due to numerous possible variations, the examples provided in the present specification and figures are directed towards symbols on socks or stockings. It will be understood by one skilled in the art in light of the present disclosure that the principles disclosed herein apply to any set of clothing and a set of clothing is not limited to socks.

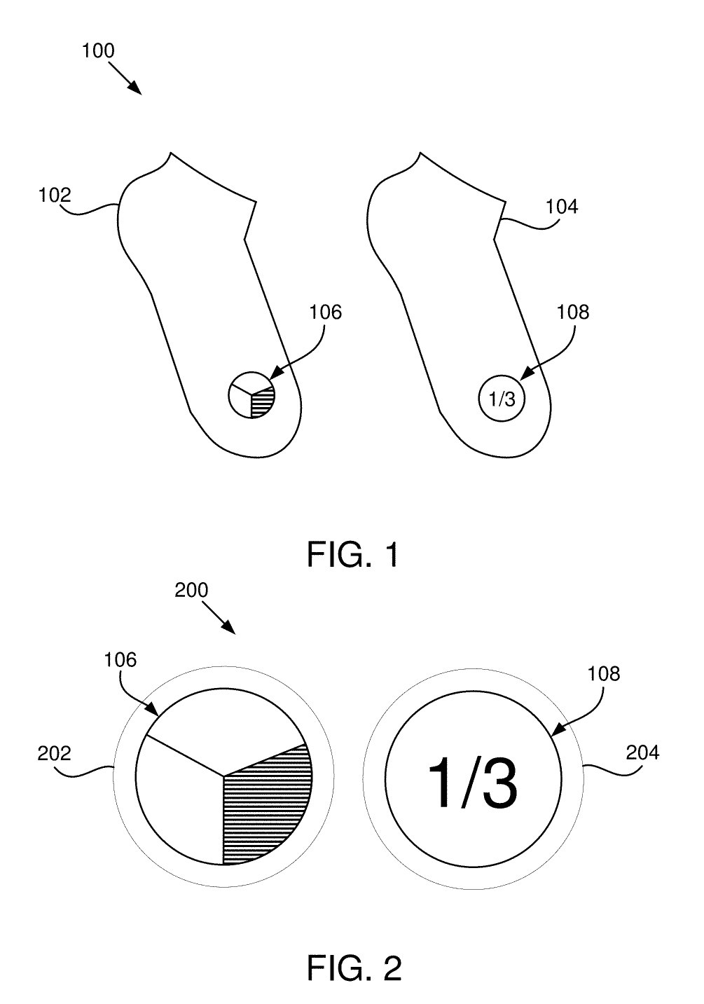

FIG. 1 depicts one embodiment of an apparatus for an elementary education learning system, comprising a pair of stockings or socks 100 includes a first sock 102 and a second sock 104. A first symbol 106, being a graphical representation of the fraction ⅓, is disposed on the toe of the first sock 102. A second symbol 108, being a numeric representation of the fraction ⅓, is disposed on the second sock 104. The symbols 106 and 108 are not the same, but are associated with one another (in this case, comprising two different ways of representing the same mathematical concept) such that a user looking to pair the socks will, by observing the symbols 106 and 108, and understanding the relationship therebetween, recognize that the socks 102 and 104 are designed to be paired. Additionally, in handling, donning, and wearing the sock pair 100, depending on the placement and orientation of the symbols, the user will observe the symbols and their relationship with each other, reinforcing the concept in the user's mind.

In some embodiments, the symbols 106, 108 as well as other symbols discussed herein [collectively “symbols”] may be included with socks 102, 104 of FIG. 1 as well as other socks discussed herein [collectively “socks”]. In some embodiments, the symbols are included when the socks are manufactured. For example, the symbols may be woven, knitted, etc. into the socks. In other embodiments, the symbols may be applied to the socks using a dye or an ink application or similar method that changes color of the socks at the location of the symbols. In some embodiments, the symbols are decals, as explained below and the decals may be applied to the socks before sale to a user or may be applied to the socks by a user.

The socks may be of various types. For example, the socks may be fitted, size specific, or one size fits most. In other embodiments, the socks may include a false heal, no heal, or may include a heal.

FIG. 2 shows a pair of decals 200 according to one embodiment. The pair of decals 200 are shown having symbols 106, 108 before they are applied to the socks 102, 104. The pair of decals 200 includes a first decal 202 having the first symbol 106 thereon and a second decal 204 having the second symbol 108 thereon. The symbols 106, 108 on the pair of decals 200 are configured to be applied to articles of clothing.

The term “decal”, according to the present specification includes a variety of apparatuses which can be used to apply or transfer the symbols 106, 108 to articles of clothing and includes heat transfers, patches, buttons, and the like. Depending on the decal, the symbols 106, 108 are applied to articles of clothing in a variety of ways. For example, if the first and second decals 202, 204 are heat transfers, the symbols 106, 108 may be applied to articles of clothing by using heat. One exemplary type of heat transfer, given by way of illustration and not limitation, is an iron on transfer.

In the case that the decals 202, 204 are iron on transfers, then the symbols 106, 108 may be applied by use of an iron, such as a household iron. According to one embodiment, this is done by heating the desired area for application of an article of clothing and the iron on transfer. For example, an iron may be used to heat the desired area of the clothing, placing the iron on transfer onto the desired area, and then heating the iron on transfer that has been placed on the clothing. The heat helps the image on the iron on transfer, such as one of symbols 106, 108, transfer from the iron on transfer to the article of clothing.

The decals 202, 204 may also be clothing patches or buttons. In this case, the symbols 106, 108 may be applied to an article of clothing by attaching a patch or button to the desired article of clothing. In one embodiment, this is done by sewing the patch or button to the article of clothing. According to another embodiment, the patch or button has an adhesive which allows the article or button to be attached to an article of clothing via the adhesive. The shapes of the decals 202, 204 of the pair of decals 200 are shown having a circular shape. The shape of the decals 202, 204 is only exemplary and may take a variety of shapes and forms.

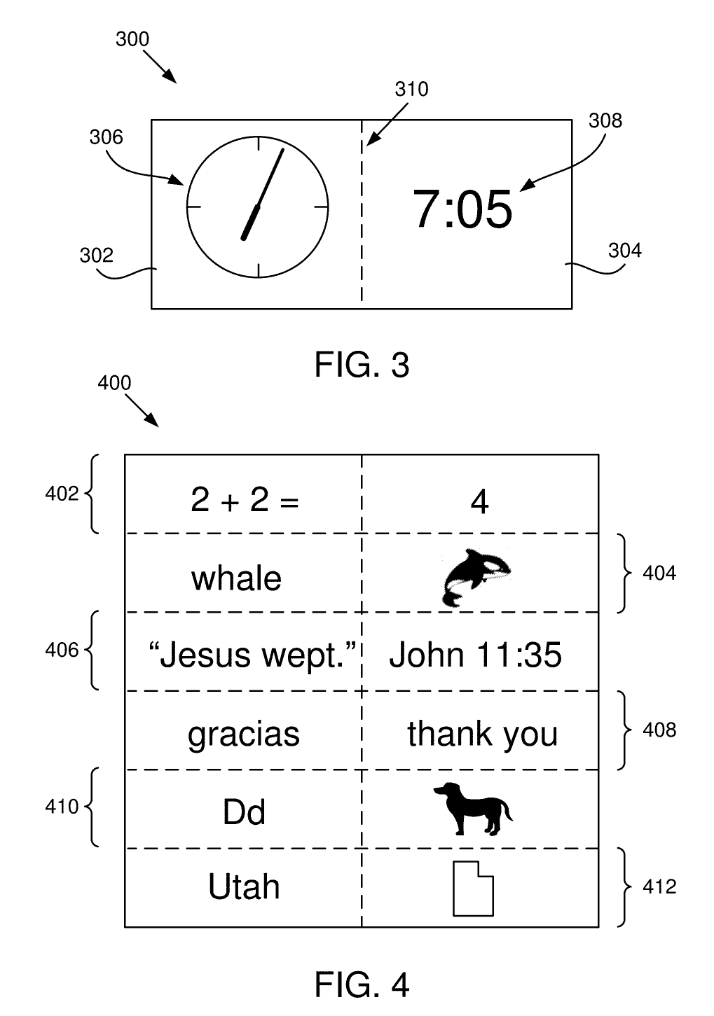

Referring now to FIG. 3, a pair of decals 300 is shown according to another embodiment. The pair of decals 300 is an iron on transfer and includes a first decal 302 having a first symbol 306 and a second decal 304 having a second symbol 308 which are on the same sheet of paper or plastic. The first symbol 306 is an analog representation of the time 7:05 as displayed on a standard analog clock. The second symbol 308 is a numeric representation of the time 7:05. Thus, the symbols 306, 308 correspond and match each other according to the relationship of representing the same time. Since the decals 302, 304 will be applied to separate articles of clothing, they may be separated by cutting along the dotted line 310 with scissors before application. Depending on the type of decal, the decals 302, 304 may also be cut to more closely follow the outline of the symbols 306, 308.

The pair of decals 300 of FIG. 3 allow the matching symbols 306, 308 to be attached to each other until they are ready to be applied to respective articles of clothing. This helps minimize the chances of losing one of the symbols 306, 308 or, in the case where an individual has a large number of decals, this helps to keep them organized. For these reasons, this may be desirable form in which to sell the decals 302, 304.

FIG. 4 shows a sheet of iron on transfers 400 having six pairs of decals 402-4124. The sheet of iron on transfers 400 of FIG. 4 is similar to the sheet of the pair of decals 300 of FIG. 3 except that the sheet of iron on transfers 400 includes six pairs 402-414 rather than just two. The decals of the six pairs of decals 402-414, similar to previous pairs of decals include symbols which correspond to and match each other.

The decals and methods of application as discussed above are only exemplary. As will be understood by one skilled in the art in light of the present disclosure, the symbols 106, 108 may be applied to articles of clothing in a variety of ways including ways not mentioned herein.

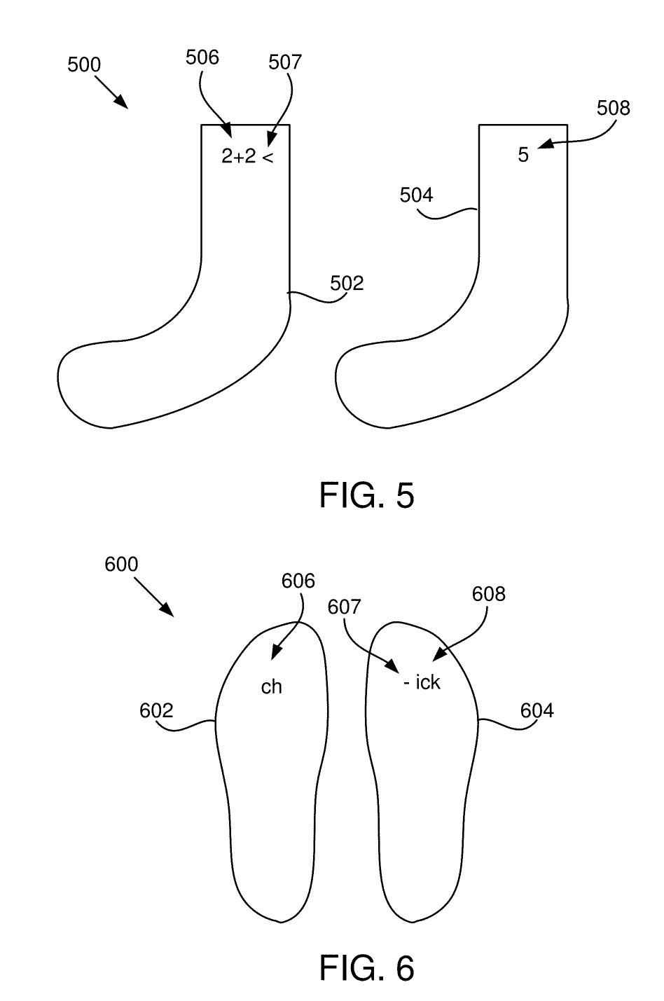

Referring now to FIG. 5, a pair of socks 500 includes a first sock 502 and a second sock 504. A first symbol or set of first symbols 506, forming the mathematical problem 2+2, is disposed on or near the top of the first sock 502 on the tube. A connective symbol 507 which is the connective symbol <, meaning “less than,” is disposed to the right of the first symbol 506 on the top of the first sock 502. A second symbol 508, which is the number 5, is disposed on or near the top of the second sock 504. As shown, the symbols 506 and 508 are disposed on a location of the socks 502 and 504 different from that shown in FIG. 1, in this case, near the top of the sock on the tube. Depending on the preference of the user, the symbols may be disposed in any location on the sock—toe, heel, leg, instep, sole, etc.—and associated symbols need not be disposed at the same respective locations, i.e., in the case of sock pair 500, the first symbol 506 might be disposed on the heel of the first sock 502 while the second symbol 508 might be disposed on the sole of the second sock 504. Different respective locations for associated symbols provide variety, while the same respective locations provide uniformity and predictability.

Most socks that make up a pair are designed to be substantially identical, i.e., displaying the same basic pattern, color, size, etc. Nevertheless, some of these substantially identical socks are designed such that one should be worn on the user's right foot while the other should be worn on the left. Examples include child's socks with bows, ribbons, or other decorations disposed on one side of the sock, the decorations being configured for display on the outside surface of the leg. Other examples include socks cut to fit around individual toes of the foot.

If the socks 502 and 504 of the pair of socks 500 are each designed for wear on a particular foot, the symbols 506 and 508 may be located on the socks such that they are symmetrical around a center line. For example, if the first sock 502 is designed to be worn on the right foot and the second sock 504 is designed to be worn on the left foot, the first symbol 506 may be located on the first sock 502 such that it is located on the right side of the sock, i.e., on the outside of the user's foot when the socks are placed on the correct feet. Similarly, the second symbol 508 may be disposed on the left side of the second sock 504.

The relationship between the symbols 506 and 508 is one of mathematical inequality; the first symbol 506 (2+2) is less than the second symbol 508 (5), as indicated by the connective symbol 507 (<). The connective symbol 507 or other mathematical connective symbols including =, /, >, *, ≡, ≠, √, ≈, and others may be used in conjunction with a set of socks according to the invention that have disposed thereon symbols that have a mathematical relationship. It will be understood by one skilled in the art that these connective symbols are only exemplary and that numerous other connective symbols may be used.

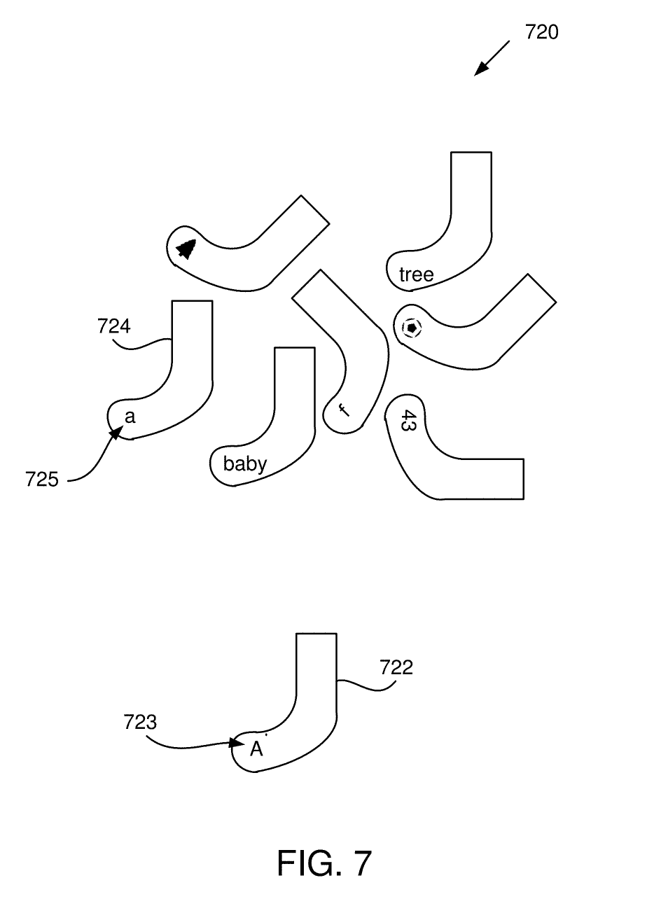

Referring now to FIG. 6, a pair of socks 600 includes a first sock 602 and a second sock 604. The socks 600 are shown in a plan view showing the top of feet covered by socks 602, 604, with the heel oriented toward the bottom of the page and the toe oriented toward the top of the page. The symbols 606 and 608 are oriented with the top of the symbol toward the toe of the sock and the bottom of the symbol toward the heel or top of the sock such that the user can see them in their proper orientation, i.e., right side up, while the sock pair 600 is being worn.

A first symbol (meaning a single symbol or set of symbols) 606, comprising the letters “ch,” is disposed on or near the toe of the first sock 602. A connective symbol 607 comprising the connective symbol “-” is disposed on the toe of the second sock 604 to the left of the second symbol 608, which second symbol 608 includes the letters “ick.” The first sock 602 is designed for wear on the user's left foot, with the second sock 604 designed for wear on the user's right foot, such that the symbols 606, 607, and 608 show “ch-ick,” or, without the connective symbol 607, the word “chick.” Such symbols are useful for teaching or reinforcing reading. Note that in the case of the sock pair 600, the connective symbol 607 is disposed on the second sock 604 (the right sock), as opposed to the left sock (the first sock 602) in the sock pair 600.

Other connective symbols may be used for symbols that are associated with each other, but not necessarily mathematically. These symbols may include, for example, -, →, ?, or letters and words such as “is the same as,” “is the capitol of,” “is from,” “uses,” “is within,” or other connective language or other symbology, according to the particular embodiment. The connective symbol may be disposed on either sock, or spread between both socks (such as splitting the connective symbol “is within” between the left and right socks such that “is” is on the left sock and “within” is on the right sock). If used, the connective symbol serves as further guidance for the user to associate the symbols, as well as to indicate which sock is configured to be placed on the left foot, and which on the right.

If a connective symbol is not used, generally it will make no difference which sock is placed on the left foot and which on the right, as symbols placed on them according to the invention will generally associate with each other whatever order they are placed in. Table 1, below, illustrates examples of related symbols that may be placed on sock pairs according to the present invention. It also illustrates examples of connective symbols that may be used with the associated symbols, if desired. As will be apparent to those skilled in the art in light of this disclosure, the connective symbols are optional. If they are used, in certain embodiments they may be placed either on the left sock (at the right of the first symbol) or on the right sock (at the left of the second symbol). As will also be apparent, the first and second symbols may be reversed in order if the connective symbols are not used. If the connective symbols are used, the order of the first and second symbols often may still be reversed, though the nature of some connective symbols makes the order of their associated first and second symbols unchangeable.

The symbols in Table 1 are only examples of almost innumerable symbols and combinations of symbols possible according to the present invention, as long as they are associated in some way.

TABLE 1

| First Symbol | Connective Symbol | Second Symbol |
|---|---|---|
| blue triangle | ≡ | Δ |
| 25¢ | is the same as | [symbol] |
| Three | = | III |
| thank you | in Spanish is | gracias |
| [symbol] | is a | mountain |
| Nose | looks like | [symbol] |
| Salt Lake City | is the capitol of | [symbol] |
| best | in cursive is | best |
| [symbol] | starts with | Z |
| “Jesus wept.” | is from | John 11:35 |
| Mt. Kilimanjaro | is in | Kenya |
| yellow and blue | → | green |
| Utah | uses | Mountain Standard Time |

The exemplary symbols shown in FIGS. 1-6 as well as Table 1 illustrate some possible relationships between relate symbols. The related symbols 106, 108 of FIGS. 1 and 2 are related in that they both represent the concept of the mathematical fraction ⅓. This may help a child to understand and conceptualize the meaning of the fraction. FIG. 3 depicts symbols 306, 308 which are related in that they both represent the same time. This relationship may help children to learn read clocks and tell time. Pair 402 of FIG. 4 depicts symbols representing the mathematical equation 2+2=4 with the symbols related in that they are equal to each other. This and similar equations may help children learn to learn how to add, subtract, multiply, divide, and/or perform other mathematical operations. Pair 404 includes symbols which are related in that they both represent a whale with one symbol in textual form and one in picture form. Such a relationship between symbols may teach or reinforce reading skills for children. The symbols of pair 406 are related in that one symbol is a quotation and the other symbol is a citation to the source of the quotation. This and similar symbol pairs may help a child to memorize information and the source of that information. Furthermore, they may also be used to reinforce positive concepts for children.

The symbols of pair 408 of FIG. 4 are related in that they are words that mean the same thing in different languages. This and similar pairs may be used to help children to learn a new language and/or expand their vocabulary in a second language. The symbols of pair 410 are related in that one symbol represents the letter which the word “dog” begins and the other symbol is a picture of a dog. This and similar relationships may help children to learn letters and how to read. Pair 412 represents a geographic relationship which may help a child to memorize geographic locations or other geographic facts. Pair 414 represents another geographic relationship where the first symbol includes a first geographical feature and the second symbol includes a second geographical feature encompassing the first geographical feature. For example, a first symbol may be a state capital and the second symbol may be the state corresponding to the state capital. For instance, Sacramento and California 414 may be a match.

One further type of relationship which may be desirable between two symbols according to the invention is an explicit query and answer, such as the first symbol being the question “43^{rd} U.S. president?” and the second symbol being the answer “George W. Bush.” Some of the discussed pairs of symbols involve an implicit query and answer, such as the question noted above without the question mark, a mathematical problem, or other implicit query, such as “blue and yellow,” with the answer being “green.” The order of the query and answer as viewed by the user may be reversed, with each symbol comprising an answer to the implicit query of the other.

Exemplary topics in which relationships may be taught include the exemplary symbols and discussed relationships are by no means exhaustive. It will be understood by one skilled in the art in light of the present disclosure that numerable

The schematic flow chart and method schematic diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

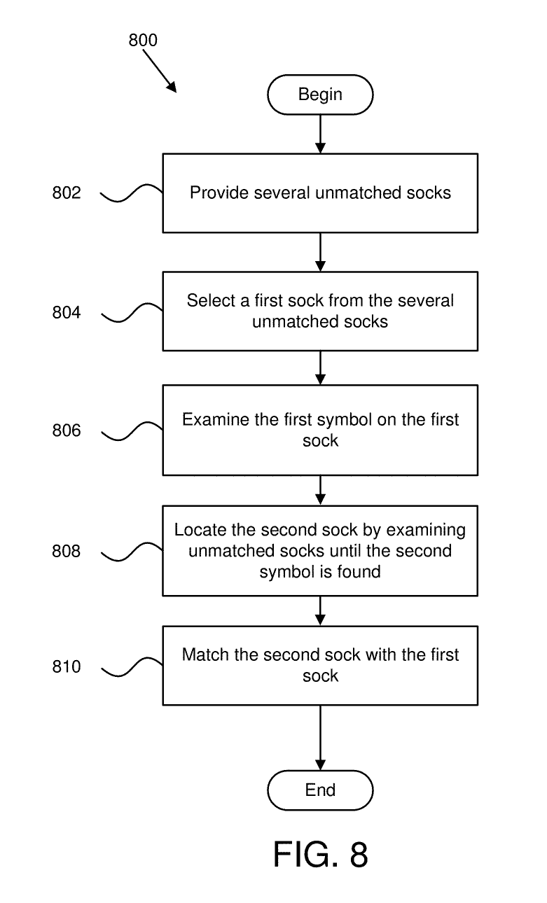

Referring now to FIGS. 7 and 8, a method 800 of choosing matching socks from several socks 702 is illustrated. The method 800 begins and several unmatched socks 720 are provided 802. The several unmatched socks 720 may be, for instance, a basket load of socks after the laundry is done. Each sock of the several unmatched socks 720 may or may not have a symbol disposed thereon, but at least two socks must each have a symbol disposed thereon according to the present invention.

A first sock 722 having disposed thereon a first symbol 723 is selected 804 from the several unmatched socks 720 and the first symbol 723 is examined 806. In the illustrated embodiment, the first symbol 723 is an upper-case “A.” A second sock 724 having disposed thereon a second symbol 725 which is associated with the first symbol 723 is then located 808 from the several unmatched socks 720. Locating 808 the second sock 724 from the several unmatched socks 720 is done by examining unmatched socks 720 until the second symbol 725 which corresponds to and matches the first symbol 723 is found. In the illustrated embodiment, the second symbol 725 is a lower-case “a,” though any symbol associated with the first symbol 723 may be used. When the first sock 722 and the second sock 724 are located and the relationship between the symbols 723, 725 is recognized and understood the socks 722, 724 are matched 810 and the method 800 ends. The method 800 may be repeated any number of times until all the matching socks have been located and paired.

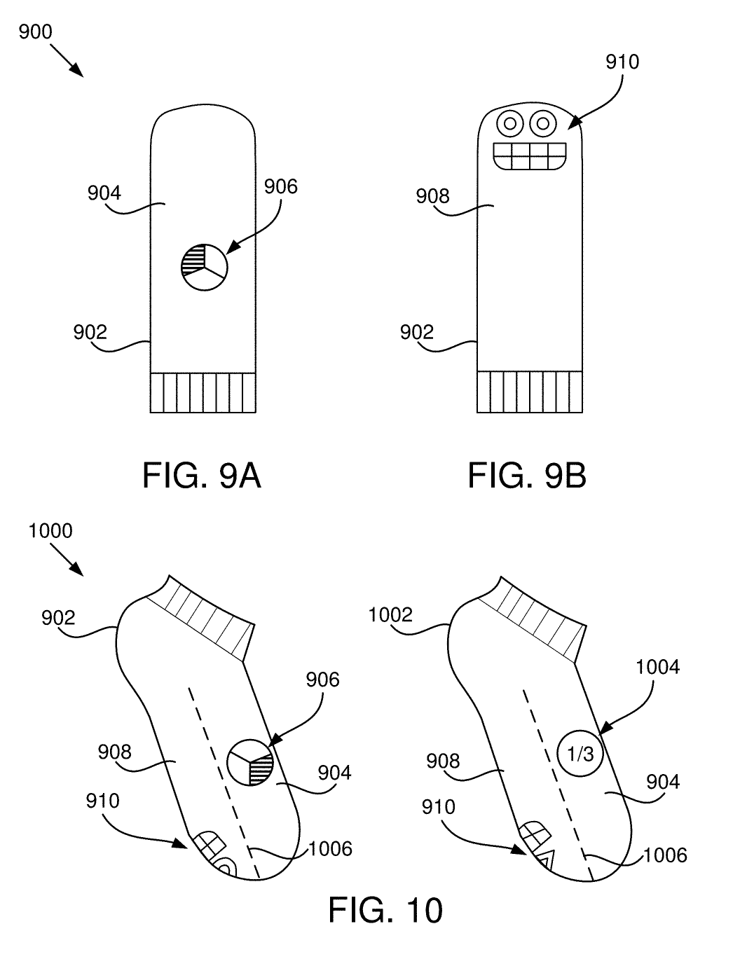

FIG. 9A depicts an apparatus 900 for an elementary education learning system. The apparatus 900 may include a first sock 902. The first sock 902 may include a first side 904. The first side 904 of the first sock 902 may include a first symbol 906 as described above in relation to FIGS. 1, 2, 5, and 6. In one embodiment, a decal, such as the first decal 202 or second decal 204 of FIG. 2, may include the first symbol 906 as described above in relation to FIG. 2.

As depicted in FIG. 9B the apparatus 900 may include a second side 908 of the first sock 902. The second side 908 may be positioned on the reverse side of the first sock 902 from the first side 904. For example, in one embodiment, the first side 904 may include the side of the first sock 902 that faces upward in response to the first sock 902 being worn by a user. The second side 908 may include the side of the first sock 902 that faces downward in response to the first sock 902 being worn by a user. In one embodiment, the second side 908 may include one or more facial features 910. The one or more facial features 910 may be disposed on a second side 908 of the first sock 902. The one or more facial features 910 may correspond to the first symbol 906 disposed on the first side 904 of the first sock 902. The one or more facial features 910 may include facial features that are non-identical to the first symbol 906 disposed on the first side 904 of the first sock 902.

In one embodiment, the one or more facial features 910 disposed on the second side 908 of the first sock 902 may correspond to the first symbol 906 disposed on the first side 904 of the first sock 902. The one or more facial features 910 corresponding to the first symbol 906 may include the one or more facial features 910 matching the first symbol 906 based on a relationship of an educational topic, as described below. In another embodiment, the first sock 902 may form a puppet in response to the first socking 902 being worn over a hand. The one or more facial features 910 may include portions of the puppet. The one or more facial features 910 and the first sock 902 may form a puppet in a variety of ways. For example, in one embodiment, the user's hand may be inserted into the opening of the first sock 902 and hold the first sock 902 over the hand. In another embodiment, the user may pinch a portion of the first sock 902 to form an indent in the portion of the first sock 902. The indent may simulate a mouth for the puppet. Pinching and releasing the portion of the first sock 902 may simulate the puppet talking.

In some embodiments, the one or more facial features 910 as described herein may be replaced with other symbols similar to the first symbol 906. Instead of facial features, there may be text, images, drawings, mathematical expressions, or other symbols. Thus, a variety of different learning methods may be achieved. The embodiments are not limited to the specific examples provided herein.

FIG. 10 depicts an embodiment of an apparatus 1000 for an elementary education learning system. The apparatus 1000 may include a pair of socks. The pair of socks may include a first sock 902 as described above in relation to FIGS. 9A-B. The first sock 902 may include a first side 904, a first symbol 906 disposed on the first side, a second side 908, and one or more facial features 910 disposed on the second side 908. The pair of socks may include a second sock 1002. The second sock 1002 may include a first side 904, a second side 908, one or more facial features 910 disposed on the second side 908, and a second symbol 1004 disposed on the first side 904 of the second sock 1002. The first symbol 906 and the second symbol 1004 are not the same, but are associated with one another such that a user looking to pair the socks will, by observing the first symbol 906 and the second symbol 1004, and understanding the relationship therebetween, recognize that the first socks 902 and the second sock 1002 are designed to be paired, as described above in relation to FIG. 1. A line 1006 is shown between the first side 904 and the second side 908, which is approximately an edge of the first sock 902 in FIG. 9A and the first sock 902 is depicted as folded so that a portion of the first side 904 and second side 908 is shown in FIG. 10. A similar line 1006 is shown on the second sock 1002.

In one embodiment, the one or more facial features 910 disposed on the second side 908 of a sock, such as the first sock 902 or the second sock 1002, may differ from the one or more facial features 910 disposed on the second side 908 of the other socks of the multiple pairs of socks. For example, as depicted in FIG. 10, in one embodiment, the one or more facial features 910 of the first sock 902 sock may include a pair of eyes. The pair of eyes may include circular eyes. The facial features 910 of the second sock 1002 may include a pair of eyes and the pair of eyes may include triangular eyes. One of skill in the art will recognize other ways that the one or more facial features 910 of each sock of the multiple socks may differ from one another.

In one embodiment, one or more facial features 910 of the first sock 902 or second sock 1002 include a non-skid material. The term “non-skid,” according to the present specification, includes a variety of materials which may increase the friction experienced between one or more surfaces. For example, in one embodiment, the non-skid material may include rubber, cork, rubber, felt, acrylic, or polyester. One of skill in the art will recognize other non-skid materials. In one embodiment, the non-skid material may mount to the second side 908 of the first sock 902 or second sock 1002. In another embodiment, the non-skid material may be sewn into the second side 908 of the first sock 902 or second sock 1002. In yet another embodiment, the non-skid material may adhere to the second side 908 of the first sock 902 or second sock 1002. One of skill in the art will recognize other ways that the second side 908 of the first sock 902 or second sock 1002 may include non-skid material.

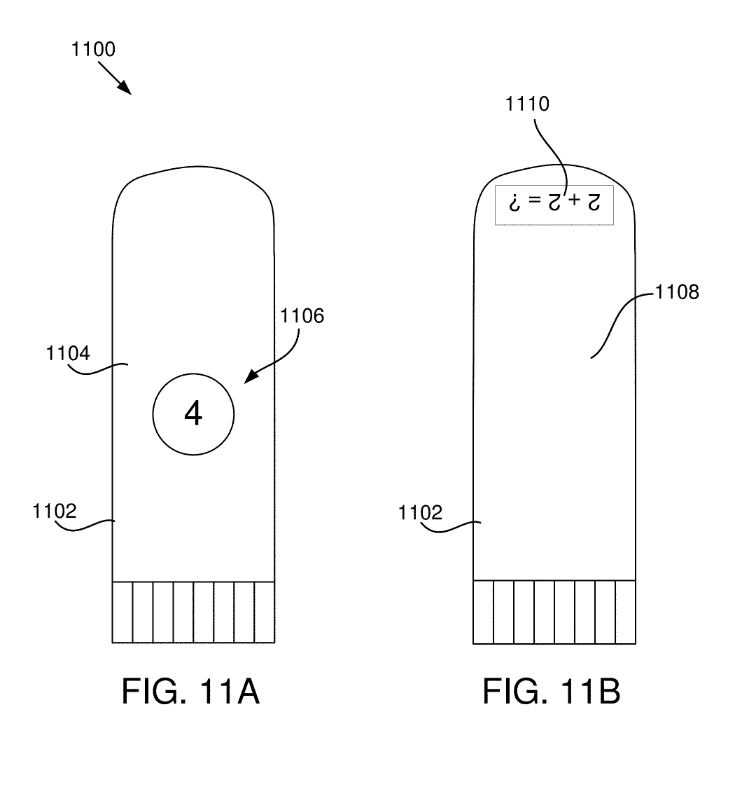

FIGS. 11A and 11B depict an embodiment of an apparatus 1100 for an elementary education learning system. The apparatus 1100 may include a sock 1102. In one embodiment, the sock 1102 may include the first sock 902 or the second sock 1002 from FIGS. 9A and 9B and 10. In another embodiment, the sock 1102 may include any other sock of the multiple socks. The sock 1102 may include a first side 1104, a second side 1108, a symbol 1106, and one or more lines of text 1110. FIG. 11A depicts the first side 1104 of the sock 1102, and FIG. 11B depicts the second side 1108 of the sock 1102.

One or more lines of text 1110 may include one or more alphanumeric, punctuation, mathematical, or the like characters that convey information. For example, in one embodiment shown in FIG. 11B, the line of text 1110 may include a mathematical equation. In one embodiment, a portion of the mathematical equation may correspond to the symbol 1106 disposed on the first side 1104 of the sock 1102. In another embodiment, the one or more lines of text 1110 may include a name of the symbol 1106 disposed on the first side 1104 of the sock 1102. For example, as depicted in FIG. 11A, the symbol 1106 may include the number “4” and the line of text 1110 in FIG. 11B may include the text “four.” One of skill in the art will recognize other ways that the one or more lines of text 1110 may correspond with the symbol 1106 on the first side 1104 of the sock 1102. Furthermore, although FIG. 11B simply depicts the one or more lines of text, it should not be understood that one or more lines of text 1110 are limited to this depiction. The one or more lines of text 1110 may be disposed within various other features as described in other illustrative embodiments, such as within the facial features 910 of FIG. 9. The embodiments are not limited to the specific examples provided herein.

In one embodiment, the symbol 1106 disposed on the first side 1104 of the sock 1102 may include a number and the second side 1108 of the sock 1102 may include facial features, such as a mouth design that may include a mouth with a number of teeth. The number of teeth may be equal to the number of the symbol 1106 on the first side 1104 of the sock 1102. For example, in one embodiment, the number of the symbol 1106 of the first side 1104 of the sock 1102 may include the number “6” and the mouth design may include six teeth.

In one embodiment, the facial features may include an instruction to a user. For example, in one embodiment, one or more eye designs or the mouth design may include one or more lines of text that include an instruction to a user. For example, the one or more lines of text may include one or more words that instruct a user to perform an action. For example, in one embodiment, the words may include “jump,” “run,” “blink,” or the like. In another embodiment, the one or more eye designs or the mouth design may include an image that includes an instruction to a user. For example, the image may include a person jumping, a person running, a pair of eyes blinking, or the like. One of skill in the art will recognize other ways that the facial features may include an instruction to a user. By containing an instruction to a user, the one or more facial features may assist a child in matching socks (as explained above in relation to FIGS. 7 and 8) by including fun instructions for the child to carry out to make the sock-matching process more enjoyable.

In one embodiment, the symbol 1106 disposed on the first side 1104 of the sock 1102 may include an image of a hand. The image of the hand may include a sign language expression. The sign language expression may include a sign language letter, a sign language word, a sign language word that includes a motion, or the like. A user may wear the sock 1102 over one hand, look at the sign language expression of the symbol 1106, and form or perform the sign language expression of the symbol 1106 of the sock 1102. The user may compare the sign language expression formed or performed by the user's hand to the sign language expression of the symbol 1106 side-by-side and improve the sign language expression formed or performed by the user's hand.

In one embodiment, the symbol 1106 symbol of the sock 1102 and one or more facial features may include images printed on the sock 1102. In another embodiment, the symbol 1106 and the one or more facial features may include a set of iron-on transfers applied to the multiple pairs of socks as described above in relation to the decals 202, 204 and as described below. In another embodiment, the symbol 1106 and the one or more facial features may include a set of clothing patches applied to the multiple pairs of socks as described above in relation to the decals 202, 204.

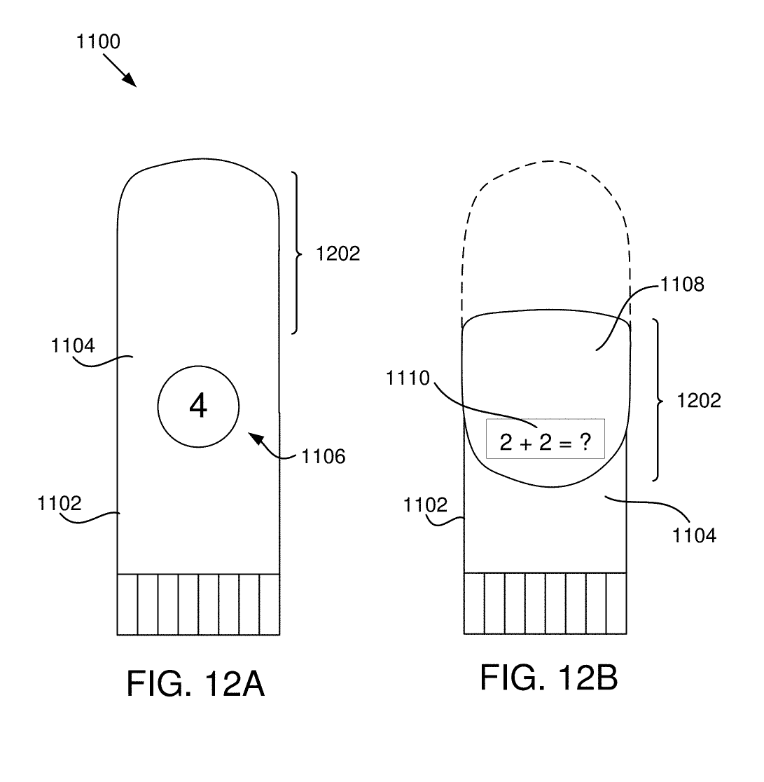

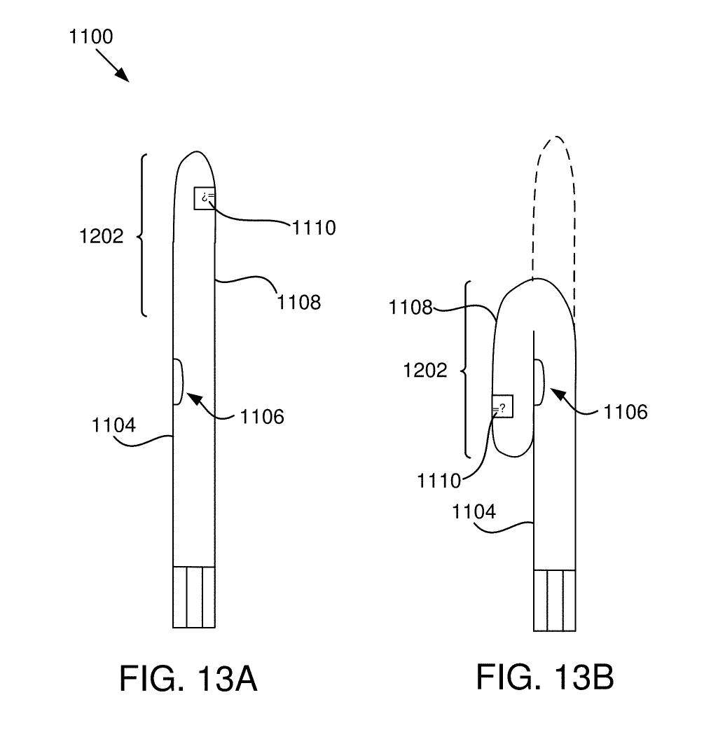

FIGS. 12 and 13 depict a memory game functionality of the embodiment of FIG. 11. FIGS. 12A and 12B depict a front view of the embodiment shown in FIG. 11 in folded and unfolded positions, and FIGS. 13A and 13B depict a side of the same embodiment depicted in FIG. 11 in the folded and unfolded positions. In FIGS. 11A and 12A, the sock 1102 is in an extended position, and in FIGS. 11B and 12B, the sock 1102 is in a folded position. As explained above, the one or more lines of text 1110 disposed at a first end 1202 of the second side 1108 of the sock 1102 correspond to the symbol 1106. Various configurations of corresponding lines of text 1110 and symbols 1106 are possible, and some illustrative examples are described herein.

A first user's hand may then be placed inside the sock 1102 and, the sock 1102 may be placed into the configuration shown in FIG. 12B. In this configuration, the line of text 1110 is displayed, and the symbol 1106 is hidden from view by the first end 1202. A second user may then read the line of text 1100, and attempt to guess the symbol 1106 that is hidden from view. After the second user guesses, the first user's hand may then be opened, thereby returning the sock 1102 to the configuration shown in FIG. 12A, wherein the line of text 1110 is no longer visible and the symbol 1106 is displayed. The second user's guess may then be evaluated and compared to the symbol 1106.

FIGS. 13A and 13B are a side view of the apparatus 1100 of FIG. 11 that demonstrates the folding memory game functionality of the embodiment of FIG. 11.

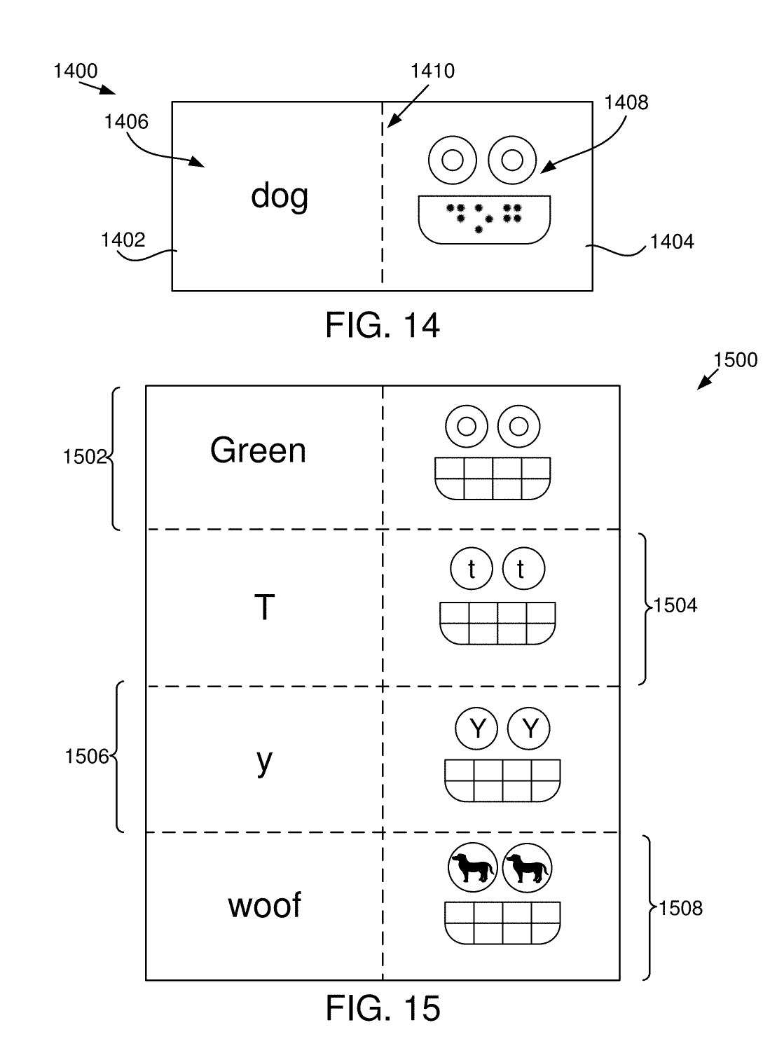

FIG. 14 depicts an embodiment of an apparatus 1400 for an elementary education learning system. The apparatus 1400 may include a pair of decals on a sheet of paper of plastic. The pair of decals may include an iron on transfer and may include a first decal 1402 having a first symbol 1406 and a second decal 1404 having one or more facial features 1408 which are on the same sheet of paper or plastic. The first symbol 1406 may include a word. The one or more facial features 1408 may include a Braille representation of the word of the one or more facial features 1408. Thus, the symbol 1406 and the one or more facial features 1408 correspond and match each other according to the relationship of representing the word. Since the decals 1402, 1404 may be applied to separate articles of clothing, the decals 1402, 1404 may be separated by cutting along the dotted line 1410 with scissors before application. Depending on the type of decal, the decals 1402, 1404 may also be cut to more closely follow the outline of the symbol 1406 and the one or more facial features 1408.

The pair of decals 1402, 1404 allow the matching symbol 1406 and facial features 1408 to be attached to each other until they are ready to be applied to respective articles of clothing. This may help minimize the chances of losing the symbol 1406 or the one or more facial features 1408 or, in the case where an individual has a large number of decals, this helps to keep them organized. For these reasons, this may be desirable form in which to sell the decals 1402, 1404.

FIG. 15 depicts an embodiment of an apparatus 1500 for an elementary education learning system. The apparatus 1500 may include a sheet of iron on transfers having four pairs of decals 1502-1508. The sheet of iron on transfers of FIG. 15 may be similar to the sheet of the pair of decals of FIG. 14 except that the sheet of iron on transfers may include six pairs 1502-1508 rather than two. The decals of the six pairs of decals 1502-1508, similar to previous pairs of decals, may include symbols and facial features which correspond to and match each other. The decals and methods of application as discussed above are only exemplary. As will be understood by one skilled in the art in light of the present disclosure, the symbol 1406 and the one or more facial features 1408 may be applied to articles of clothing in a variety of ways including ways not mentioned herein.

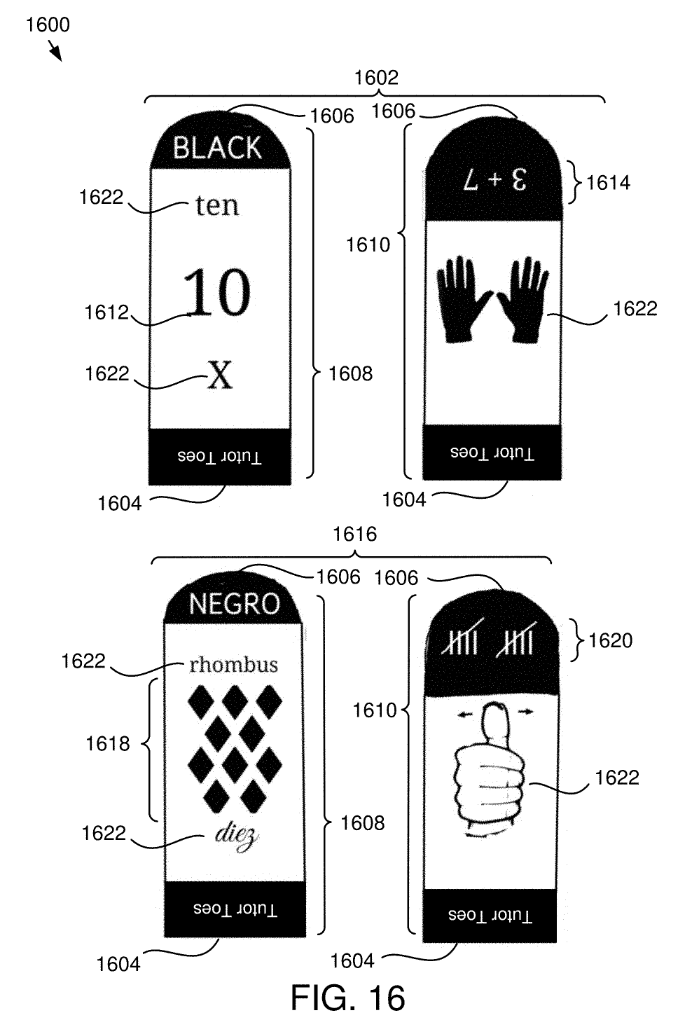

FIG. 16 depicts an embodiment of an apparatus 1600 for educating children. The apparatus includes a sock. In some embodiments, the sock may comprise a first sock 1602. The first sock 1602 comprises a garment designed to be worn on a foot. The first sock 1602 may comprise a variety of different materials, such as cotton, polyester, or other suitable garment materials. The first sock 1602 may include an open end 1604 and a closed end 1606. The closed end 1606 may be positioned distal to the open end 1604.

The first sock 1602 also includes a first side 1608 and a second side 1610 opposite the first side 1608. The first side 1608 and the second side 1610 are positioned between the closed end 1606 and the open end 1604. In one embodiment, the first side 1608 is worn on a top of a user's foot and the second side 1610 is worn on a bottom of a user's foot. In another embodiment, the first side 1608 is worn on a bottom of a user's foot and the second side 1610 is worn on a top of a user's foot.

The first sock 1602 may also include a first sock symbol 1612. The first sock symbol 1612 may be located on the first side 1608 of the first sock 1602. The first sock symbol 1612 may have a top and a bottom, and, in some embodiments, the top of the first sock symbol 1612 may be oriented towards the closed end of the first sock 1602.

The first sock 1602 may also include a second sock symbol 1614. The second sock symbol 1614 may be located on the second side 1610 of the first sock 1602. The second sock symbol 1614 may have a top and a bottom, and, in some embodiments, the bottom of the second sock symbol 1614 may be oriented towards the closed end of the first sock 1602.

Both the first sock symbol 1612 and the second sock symbol 1614 may comprise a variety of symbols, including but not limited to one or more of an alphanumeric character, a word, punctuation, a mathematical symbol, a mathematical equation, a mathematical expression, a color and text. In other embodiments, the first sock symbol 1612 and/or the second sock symbol 1614 may comprise other symbols. In some embodiments, the first sock symbol 1612 and the second sock symbol 1614 may comprise different symbols. There are various combinations possible that have not been specifically enumerated herein, and the embodiments are not limited to the specific examples provided herein.

In some embodiments, an end of the first sock 1602 may be bent towards the first side 1608 of the first sock 1602. This bending action may be performed while the sock rests on the floor, a tabletop or other surface, while hung on a clothesline, may occur with a hand of a user inserted into the first sock 1602, or in other ways not specifically mentioned herein. In some embodiments, this bending is done at a location below the second sock symbol 1614. In some embodiments, below refers to a direction towards the open end 1604 of the first sock 1602. By bending the sock in this way, the second sock symbol 1614 may be inverted, and the second sock symbol 1614 and a portion of the second side 1610 are placed in a position to be viewed from the first side 1608 of the first sock 1602. In some embodiments, this bending may additionally cover up the first sock symbol 1612 disposed on the first side of the first sock 1602.

In other embodiments, the bending may be made towards the second side 1610 of the first sock 1602 (instead of towards the first side 1608 of the first sock 1602), therefore displaying the first sock symbol 1612 and covering up the second sock symbol 1614.

In some embodiments, the first sock symbol 1612 may be different from the second sock symbol 1614. In some embodiments, though the first sock symbol 1612 and the second sock symbol 1614 may be different, they may still be related through a topic. In some embodiments, a topic that relates the first sock symbol 1612 and the second sock symbol 1614 is referred to as a single sock topic. As explained above, and as the name implies, this topic relates symbols on a single sock to one another.

By including the various symbols and topics relating those symbols on the first sock 1602, the first sock 1602 by itself forms a learning system whereby the user learns about the symbols on the first sock 1602, including the first sock symbol 1612, the second sock symbol 1614, and any additional symbols on the sock, as well as the topics and relations that relate the symbols on the first sock 1612 to one another. For example, a user can try to discern the relationship between the various symbols, can practice memorizing a symbol's meaning using the other symbols on the first sock 1612 as hints or helps, or can use other methods of learning using the first sock 1612 alone.

In some embodiments, the apparatus 1600 further includes a second sock 1616. The second sock 1616 may comprise a garment designed to be worn on a foot. The second sock 1616 may comprise a variety of different materials, such as cotton, polyester, or other suitable garment materials. The second sock 1616 may include an open end 1604 and a closed end 1606. The closed end 1606 may be positioned distal to the open end 1604.

The second sock 1616 may also include a first side 1608 and a second side 1610 opposite the first side 1608. The first side 1608 and the second side 1610 are positioned between the closed end 1606 and the open end 1604 of the second sock 1616.

The second sock 1616 may also include a third sock symbol 1618. The third sock symbol 1618 may be located on the first side 1608 of the second sock 1616. The third sock symbol 1618 may have a top and a bottom, and the top of the third sock symbol 1618 may be oriented towards the closed end of the second sock 1616.

The second sock 1616 may also include a fourth sock symbol 1620. The fourth sock symbol 1620 may be located on the second side 1610 of the second sock 1616. The fourth sock symbol 1620 may have a top and a bottom, and the bottom of the fourth sock symbol 1620 may be oriented towards the closed end of the second sock.

Both the third sock symbol 1618 and the fourth sock symbol 1620 may comprise a variety of symbols, including but not limited to one or more of an alphanumeric character, a word, punctuation, a mathematical symbol, a mathematical equation, a mathematical expression, a color and text. In other embodiments, the third sock symbol 1618 and/or the fourth sock symbol 1620 may comprise other symbols. In some embodiments, the third sock symbol 1618 and the fourth sock symbol 1620 may comprise different symbols. There are various combinations possible that have not been specifically enumerated herein, and the embodiments are not limited to the specific examples provided herein.

In some embodiments, an end of the second sock 1616 may be bent towards the first side 1608 of the second sock. This bending action may be performed while the sock rests on the floor, a tabletop or other surface, while hung on a clothesline, may occur with a hand of a user inserted into the second sock 1616, or in other ways not specifically mentioned herein. In some embodiments, this bending is done at a location below the fourth sock symbol 1620. In some embodiments, below refers to a direction towards the open end 1604 of the second sock 1616. By bending the second sock 1616 in this way, the fourth sock symbol 1620 may be inverted, and the fourth sock symbol 1620 and a portion of the second side 1610 are placed in a position to be viewed from the first side 1608 of the second sock. In some embodiments, this bending may additionally cover up the third sock symbol 1618 disposed on the first side of the sock.

In other embodiments, the bending may be made towards the second side 1610 of the second sock 1616 (instead of towards the first side 1608 of the second sock 1616), therefore displaying the third sock symbol 1618 and covering up the fourth sock symbol 1620.

In some embodiments, the third sock symbol 1618 may be different from the fourth sock symbol 1620. In some embodiments, though the third sock symbol 1618 and the fourth sock symbol 1620 may be different, they may still be related to a single topic. Herein, this topic that relates the first sock symbol 1612 and the second sock symbol 1614 is referred to as a single sock topic. As explained above, and as the name implies, this topic relates symbol on a single sock to one another.

In some embodiments, one or more of the first sock symbol 1612 and the second sock symbol 1614 of the first sock 1602 are related to one or more of the third sock symbol 1618 and the fourth sock symbol 1620, even though the various symbols may be different. In some embodiments, this relation is expressed through a same sock pair topic. In such a relation, though the same sock pair topic demonstrates a particular relationship or topics, in some embodiments the symbols used in this same sock pair topic may be used to demonstrate other topics or relationships through the other topics described herein. In some embodiments, the same sock pair topic may be unique, and in other embodiments, the same sock pair topic may be a similar topic to another topic described herein or may even be the exact same topic as another topic described herein. This versatility and variability of the different topics is useful in instruction, as some learners may require various approaches to a certain topic, while others may need repetition of a single approach to learning, and yet others may need a combination of the two.

As discussed herein, the apparatus takes advantage of various topics and relations, including various same sock topics, same sock pair topics, same side sock topics, and others. In some embodiments, each of these topics and relations is unique, and there is no overlap. In some embodiments, though they are distinct topics, some or all of the topics may be topics that are related by a more general topic. In yet further embodiments, some or all of the topics may comprise the same topic.

Various combinations are possible. For example, a same sock topic may be the quantity 10, a same side sock topic may be numerals written in different forms such as 10, ten, or X, another same side sock topic may be graphic representations of the quantity 10 using shapes, and a same sock pair topic may include numbers/quantities in general. In another example, a same side sock topic of a single sock may be the quantity five, another same side sock topic of a single sock (on the opposite side of the same sock) may be the shape of pentagons, the same sock topic may be the quantity five, and the same sock pair topic may be numbers/quantities in general. As is obvious, the first same side sock topic and the same sock topic are both the quantity of five. Since the second same side sock topic has to do with the shape of pentagons and pentagons have five sides, the same sock topic of five is maintained, yet different expressions of that topic provide for additional learning. As quickly becomes obvious, there are a multitude of possibilities and combinations of expressing various topics, and the embodiments are not limited to the specific embodiments detailed herein.

As mentioned herein, these topics include a single sock topic for the first sock 1602, a single sock topic for the second sock 1616, a same sock pair topic, and a same side sock topic, and may include other topics. Any or all of these topics, as well as other topics not specifically mentioned, may include a variety of topics. In some embodiments, each of these topics may include one or more of a mathematical topic, a phonetic topic, a language learning topic, a foreign language learning topic, a geography topic, a sign language topic, a geometric topic, a history topic, a science topic and a literary topic. By doing so, the apparatus is capable of teaching a variety of different topics, in a variety of different ways, thus increasing the effectiveness and versatility of the apparatus.

In some embodiments, the apparatus includes a plurality of pairs of socks. In some embodiments, each pair of socks of the plurality of pairs of socks includes a first sock 1602 bearing a first sock symbol 1612 and a second sock symbol 1614 as described herein, as well as a second sock bearing a third sock symbol 1618 and fourth sock symbol 1620. In such an arrangement, the same sock topics and the same sock pair topics of each pair of socks is different from the same sock topics and same sock pair topic of other pairs of socks in the plurality of pairs of socks. For example, in a first pair of socks of the plurality of pairs of socks, the same sock topic of the first sock may include the quantity 10.

In the same pair of the plurality of pairs of socks, the same sock topic of the second sock may include a shape such as a triangle. The same sock pair topic of such a pair may comprise a color, such as black. In contrast, another pair of the plurality of pairs of socks may include different same sock topics and a different same sock pair topic. For example, the same sock topic of the first song of the second pair of socks of the plurality of pairs of socks may include the quantity five in the same sock topic of the second sock may include a shape such as a rectangle. The same sock pair topic of such a pair may include a color such as green. Though in this example there are correlations between the different pairs of socks this is not required to be so. Various combinations of different types of topics may be present in various embodiments.

Also, it is not always required that the topics of different pairs of socks and the plurality of pairs of socks be different. It may be the case that in some embodiments these topics are actually similar or even the same topics. It is readily apparent that different combinations may exist and the embodiments are not limited to the specific examples provided herein. This variety and of possible combinations provides the embodiments with versatility to teach concepts in different ways that will increase the learning of the user.

In some embodiments, the various pairs of socks of the plurality of pairs of socks may form a sock matching game. In such an embodiment, each pair of socks of the plurality of pairs of socks comprises a first sock 1602 and a second sock 1616, each with its respective features as described herein. Each of these pairs of socks includes a unique same sock pair topic that differs from each other same sock pair topic present in the plurality of pairs of socks. In such an embodiment, the user then matches the first sock 1602 with the second sock 1616 of the same pair of socks based on the unique same sock pair topic of the pair of socks. The user then continues by matching each first sock 1602 of the pair of socks with the second sock 1616 of the same pair of socks based on the unique same sock pair topic.

As each same sock pair topic is unique to that pair of socks, there is only one combination that is correct for each pair of socks. Thus, an effective matching game is formed which teaches the various topics and relations found between the first sock 1602 and the second sock 1616 of each pair of socks. For example, the same sock pair topic of one pair of socks may be the quantity eight. The same sock pair topic of another pair of socks may be the shape of a triangle. Yet another same sock pair topic of a third pair of socks may include the color red. Thus, as can be seen each same sock pair topic is unique, and thus each first sock 1602 of each pair of socks may be matched with each second sock 1616 of each pair of socks. This is an effective matching game that may be used to teach various topics and relations.

In some embodiments, the first sock 1602 and the second sock 1616 for interchangeable in that each sock may be worn on either the left or right foot of the user. In other words, the first sock 1602 is not designed specifically for either the left or the right foot, nor is the second sock 1616 designed specifically for either the left or the right foot. In some embodiments, there may be symbols on the first sock 1602 and the second sock 1616 designating a foot on which the sock should be worn, but these symbols would be only for use in teaching the concepts of left and right to the user, and would likely not indicate any physical difference in the socks that would affect their wearability on either foot.

In some embodiments, the first side 1608 of the first sock 1602 includes one or more additional sock symbols 1622 in addition to the first sock symbol 1612. In some embodiments, the additional sock symbol 1622 are oriented with the top towards the closed end 1606 of the first sock 1602. In other embodiments, the additional sock symbol 1622 may be oriented in a different manner to accommodate specific symbols, specific learning goals, or for other reasons. The additional sock symbol 1622 of the first side 1608 of the first sock 1602 are related to the first sock symbol 1612 by the same side sock topic of the first side 1608 of the first sock 1602.

Likewise, the first side 1608 of the second sock 1616 may also include one or more additional sock symbol 1622 that are related to the third sock symbol 1618 located on the first side 1608 of the second sock 1616. In some embodiments, the additional sock symbol 1622 of the first side 1608 of the second sock 1616 are oriented with the top towards the closed end 1606 of the second sock 1616. In other embodiments, the additional sock symbol 1622 may be oriented in a different manner to accommodate specific symbols, specific learning goals, or for other reasons. The additional sock symbol 1622 of the first side 1608 of the second sock 1616 may be related to the third sock symbol 1618 through the same side sock topic of the first side 1608 of the second sock 1616.

An example may be illustrative. If the first sock symbol 1612 is the numeric symbol “10”, the additional sock symbol 1622 may include a roman numeral “X” expressing the same quantity but with a different symbol. Yet another additional sock symbol 1622 may include the word “ten” written out in English. Thus additional learning and connections to a topic may be learned by the user through the use of the additional sock symbol 1622. As can be seen there are various combinations possible, and the embodiments are not limited to the specific examples provided herein.

In some embodiments, the second side 1610 of the first sock includes one or more additional sock symbol 1622 in addition to the second sock symbol 1614. In some embodiments, the additional sock symbol 1622 of the second side 1610 of the first sock 1602 are oriented with the top towards the closed end 1606 of the first sock 1602. In other embodiments, the additional sock symbol 1622 may be oriented in a different manner to accommodate specific symbols, specific learning goals, or for other reasons. In some embodiments, the additional sock symbol 1622 of the second side 1610 of the first sock 1602 are related to the second sock symbol 1614 by the same side sock topic of the second side 1610 of the first sock 1602.

Likewise, the second side 1610 of the second sock 1616 may also include one or more additional sock symbol 1622 that are related to the fourth sock symbol 1620 located on the second side 1610 of the second sock 1616. In some embodiments, the additional sock symbol 1622 of the second side 1610 of the second sock 1616 are oriented with the top towards the closed end 1606 of the second sock 1616. In other embodiments, the additional sock symbol 1622 may be oriented in a different manner to accommodate specific symbols, specific learning goals, or for other reasons. The additional sock symbol 1622 of the second side 1610 of the second sock 1616 may be related to fourth sock symbol 1620 through the same side sock topic of the second side 1610 of the second sock 1616.

An example may be illustrative. If the fourth sock symbol 1620 displayed on the second side 1610 of the second sock 1616 is the numeric symbol “15”, the additional sock symbol 1622 of the second side 1610 of the second sock 1616 may include a roman numeral “XV” expressing the same quantity but with a different symbol. Yet another additional sock symbol 1622 may include the word “fifteen” written out in English. Thus, additional learning and connections to a topic may be learned by the user through the use of the additional sock symbol 1622. As can be seen there are various combinations possible, and the embodiments are not limited to the specific examples provided herein.

In some embodiments, the first sock 1602 or the second sock 1616 of a pair of socks may also be used as a sock puppet. In such an embodiment, the user may place his or her hand into the sock with a palm of the hand facing the first side of the sock (be it the first sock 1602 or the second sock 1616). In this manner, the user may perform the bending action of the first sock 1602 or the second sock 1616 as described herein with the bending of the hand.

While the user has his or her hand in the first sock 1602 or the second sock 1616 of a pair of socks, the user may also perform a “twist of the wrist” action that completely hides a side from view, and completely exposes another side for viewing by another user. For example, the first user with his or her hand inside the first sock 1602 may completely display the first side 1608 of the first sock 1602 to the second user in an upwards direction, and the second side 1610 of the first sock is completely hidden from the view of the second user, and faces in a downward direction. The first user then rotates the first sock 1602 such that the first side 1608 is completely hidden from the view of the second user and faces in a downward direction, and the second side 1610 is facing in an upward direction, completely exposed to the view of the second user. Through this functionality, the second user may explore the relationships between the various symbols disposed on the first side 1608 and the second side 160 of the sock being used. By providing this functionality, the embodiments also provide a unique learning method taught through the user of different relationships between symbols, especially when considering that a single symbol can help teach various relationships or topics based on its own characteristics and the characteristics of the other various symbols used in the different uses.

However, actions or movements made with the sock to demonstrate different relationships or topics are not limited to those occurring while a user has a hand in the sock. For example, the bending or folding action may be performed while the sock rests on the floor, a tabletop or other surface, or while hung on a clothesline. The rotating action described above could also be performed in similar circumstances by simply turning the entire sock over to expose different symbols. As can be seen, the embodiments provide a variety of uses for multiple situations. The embodiments are not limited to the specific examples provided herein.

The symbols of the apparatus, including the first sock symbol 1612, the second sock symbol 1614, the third sock symbol 1618, the fourth sock symbol 1620 and any additional sock symbol 1622 may be provided in a variety of ways. For example, the symbols previously mentioned may be images that are printed on a sock, iron-on transfers applied to a sock, or a clothing patch applied to a sock. Furthermore, the symbols may also comprise an anti-skid or non-skid material that is applied to the sock in the form of the various symbols used. Thus, the symbols that provide the learning and teaching functionality described herein also provide safety functionality while the socks are being worn. Such a material also provided a pleasing tactile response and feedback for the user. In fact, with such a material providing a more tactile response and feedback, the symbols previously mentioned may also comprise braille lettering.

In some embodiments, a sock of the apparatus may also provide additional bending functionality. In some embodiments, an end of the first sock 1602 may be bent towards the first side 1608 of the first sock 1602. In some embodiments, this bending is done at a location below the second sock symbol 1614. In some embodiments, below refers to a direction towards the open end 1604 of the first sock 1602. By bending the sock in this way, the second sock symbol 1614 may be inverted, and the second sock symbol 1614 and a portion of the second side 1610 are placed in a position to be viewed from the first side 1608 of the first sock 1602. In contrast to the earlier bending function described herein wherein the first sock symbol 1612 displayed on the first side 1608 of the first sock 1602 is covered, this additional bending functionality covers all of the symbols on the first side 1608 of the first sock 1602, including the first sock symbol 1612 and any additional sock symbol 1622 displayed on the first side 1608 of the first sock 1602.

It should be noted that this functionality is equally as applicable to the second sock 1616. In such embodiments, an end of the second sock 1616 may be bent towards the first side 1608 of the second sock 1616. In some embodiments, this bending is done at a location below the fourth sock symbol 1620. In some embodiments, below refers to a direction towards the open end 1604 of the first sock 1602. By bending the second sock 1616 in this way, the fourth sock symbol 1620 may be inverted, and the fourth sock symbol 1620 and a portion of the second side 1610 are placed in a position to be viewed from the first side 1608 of the second sock 1616. In contrast to the earlier bending function described herein wherein the third sock symbol 1618 displayed on the first side 1608 of the first sock 1602 is covered, this additional bending functionality covers all of the symbols on the first side 1608 of the second sock 1616, including the third sock symbol 1618 and any additional sock symbol 1622 displayed on the first side 1608 of the second sock 1616.

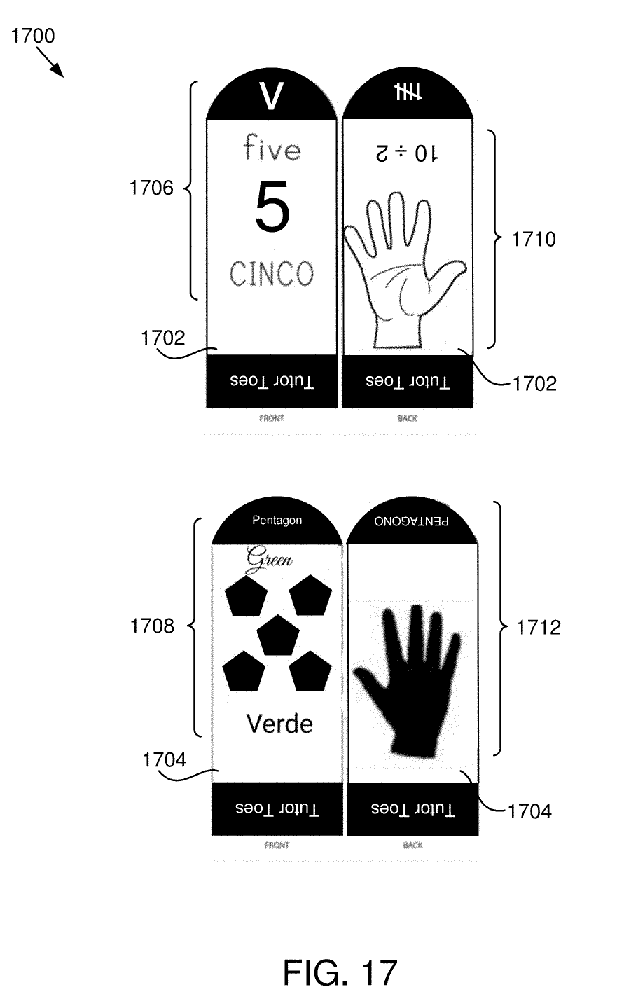

FIG. 17 depicts an embodiment of an apparatus 1700 for an elementary education learning system. The apparatus 1700 comprises a pair of socks comprising a first sock 1702 and a second sock 1704. Each of the socks comprises includes various symbols disposed in various locations on the socks. There are various relationships between the symbols that can be used to teach different educational topics using the same apparatus 1700.

These relationships can relate to a variety of topics. For example, Table 1 herein shows a variety of different topics and relationships between various symbols relating to those topics that could be used with the apparatus 1700. Yet other examples of relationships between symbols all relating to a topic are found herein. However, the embodiments are not limited to the specific examples found herein. Different embodiments may utilize other relationship and topics not specifically discussed herein.

Other examples given herein explain a variety of relationships possible. One previous relationship explained herein described the relationship between symbols that are located on two different articles of clothing that can then be matched up. Another example provided a relationship between a first symbol on one side of a sock that is hidden by an end of the sock when folded over, and a second symbol then becomes visible after the sock is folded over.

Such relationships need not exist independently. Indeed, various relationships could be combined in one embodiment to make an effective learning system that can be used in various ways. The apparatus 1700 of FIG. 17 is one such embodiment that combines various relationships described herein.

As explained herein in other exemplary embodiments, a relationship may be found between symbols disposed on different socks. For example, in FIG. 17, the first sock 1702 bears first sock front symbols 1706 (i.e. first sock symbol 1612 and additional sock symbols 1622) that correspond to a set of second sock front symbols 1708 (i.e. third sock symbol 1618 and additional sock symbols 1622) on the second sock 1704. Furthermore, the second sock front symbols 1708 correspond to the first sock back symbols 1710 (i.e. second sock symbol 1612 and additional sock symbols 1622), and the first sock front symbols 1706 also correspond to the second sock back symbols 1712 (i.e. fourth sock symbol 1620 and additional sock symbols 1622).

For example, in FIG. 16, the first sock front symbols 1706 include symbols “five”, “5”, “V” and “cinco” all of which are different ways of representing the quantity 5. The second sock front symbols 1708 include five pentagons that also represent that same quantity of 5 represented with the first sock front symbols 1706. This relation is further extended by the first sock back symbols 1710, which include a hand with five outstretched fingers, and a mathematical expression that evaluates to the quantity 5. Thus, a relation between symbols of different socks can be used in various ways to teach an educational concept to children though images, text, mathematics and other symbols. This relationship may be used in a game where multiple articles of clothing are matched together either when on the floor, in a laundry basket, when placed on feet, when placed on hands, or in other situations.

As explained herein in other exemplary embodiments, a relationship may be found between symbols on two sides of a single sock. For example, in FIG. 17, the first sock 1702 bears first sock front symbols 1706 and first sock back symbols 1710. Likewise, the second sock 1704 bears second sock front symbols 1708 and second sock back symbols 1712. For each single sock, there is a relation between the front symbols and the back symbols that is used in the elementary education learning system. In specific, the first sock front symbols 1706 correspond to the first sock back symbols 1710, and the second sock front symbols 1708 correspond to the second sock back symbols 1712.

For example, in FIG. 17, the first sock front symbols 1706 include symbols “five” “5” “V” and “cinco” all of which are different ways of representing the quantity 5. The first sock back symbols 1710 include a hand with five outstretched fingers, and a mathematical expression that evaluates to the quantity 5. Thus, the first sock 1702 shows a relation between the first sock front symbols 1706 and the first sock back symbols 1710 that can be used in the elementary education learning system.

Likewise, the second sock front symbols 1708 include five pentagons, which indicate the quantity 5 both by the number of pentagons presents, as well as the number of sides on each pentagon (which, by definition, is 5 as well). The second sock back symbols 1712 includes an outstretched hand with five outstretched fingers. Thus, the second sock 1704 shows a relation between the second sock front symbols 1708 and the second sock back symbols 1712 that can be used in the elementary education learning system.

This relationship can be used in teaching children simply by flipping over the sock to alternately display the front symbols and the back symbols of a sock. The sock could be used on the floor, where it is simply flipped over; on a hand, where a twist of the wrist of the wearer can display either side of the sock; on a foot, where raising and lowering one's leg may alternately display the two sides of the sock; or in other situations where the two sides of the sock can be displayed to the learner.

This same relationship between the front symbols of the sock and the back symbols of the sock can also be exploited when the sock is used in a memory game situation. The sock can be alternately folded over to display one side's symbols, and then opened to display the other side's symbols. This functionality is described herein in more detail.

In some embodiments, such as the embodiment of FIG. 17, these different relationships and teaching approaches (as well as others not specifically mentioned herein) can all be used in one pair of socks. Thus, instead of simply providing only one method of matching (such as simple matching between different socks, or simply matching one side of a sock to the other side), various approaches to matching, memorization and learning can be applied to one set of socks, greatly increasing the utility of the pair of socks in the elementary education teaching system.

Other relationships, symbols, locations of symbols, and topics for teaching could be included in other embodiments, even though they are not specifically provided herein as examples. Other combinations of relationships, location of symbols, and topics fall within the scope of the embodiments, even if they are not specifically mentioned herein.

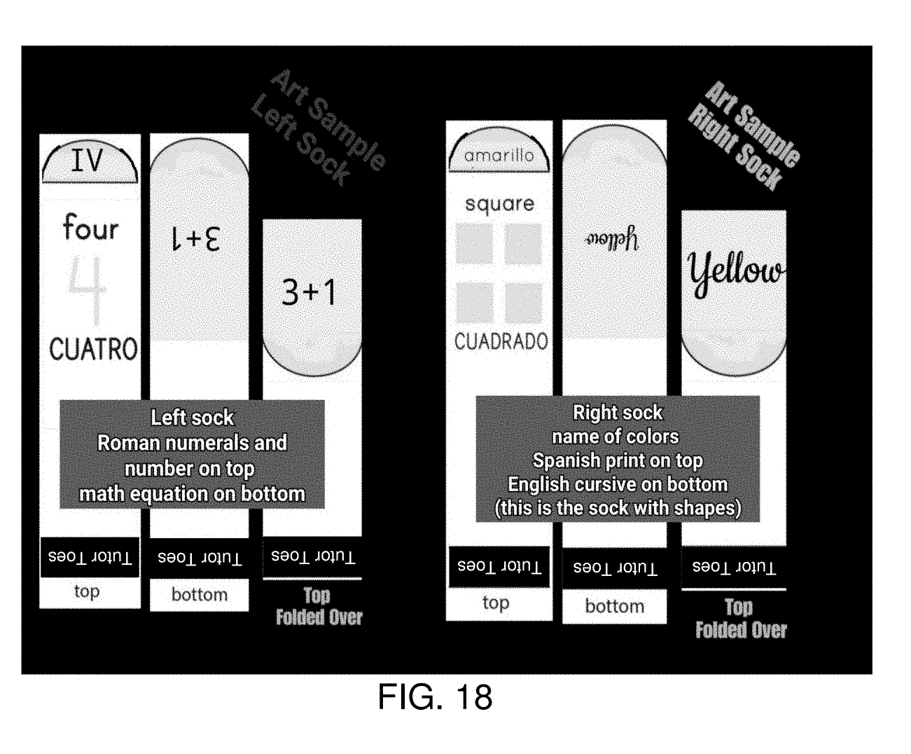

FIG. 18 depicts one pair of socks in an embodiment of an elementary education learning system. As can be seen, the pair of socks bears various symbols on the front and back of each sock. For example, the left sock bears a predominant theme of the quantity “4,” bearing various expressions of this quantity in various ways, including numerals, mathematical expressions, and foreign language expressions. The right sock contains a predominant theme of the color yellow, expressed in various ways, including actual coloring of portions of the sock, the written word “yellow”, coloring of certain symbols, and foreign language expressions of the color yellow. As can be seen, there are various intermingling topics here, including a same sock topic, a same sock pair topic, and a same side sock topic. Each of these topics may be exploited for instruction and learning, either alone or in combination.

The socks also demonstrate the folding or bending functionality discussed herein, where one end of the sock is folded over to cover symbols of one side of the sock, and displaying symbols of another side of the sock.

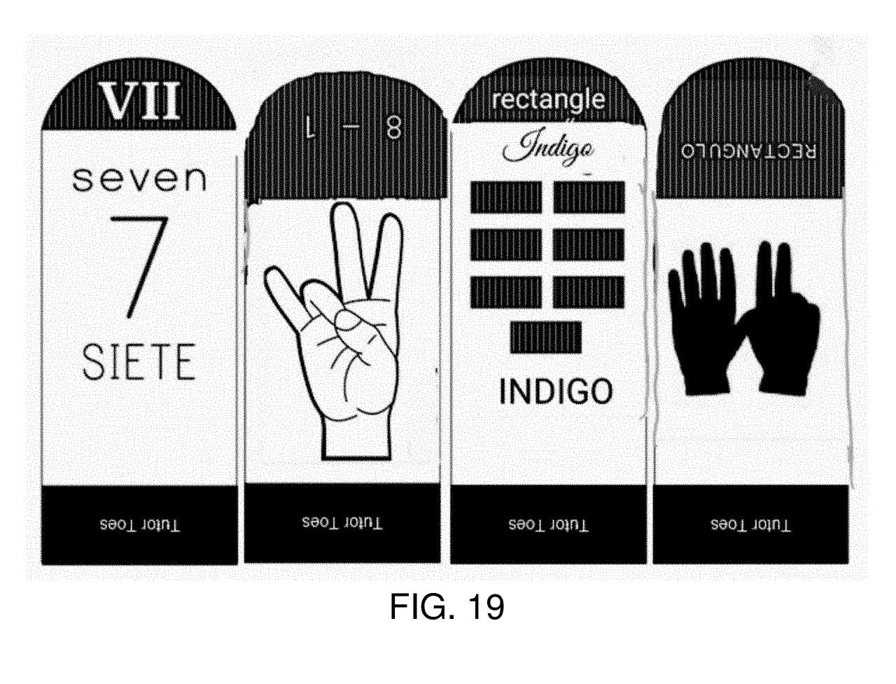

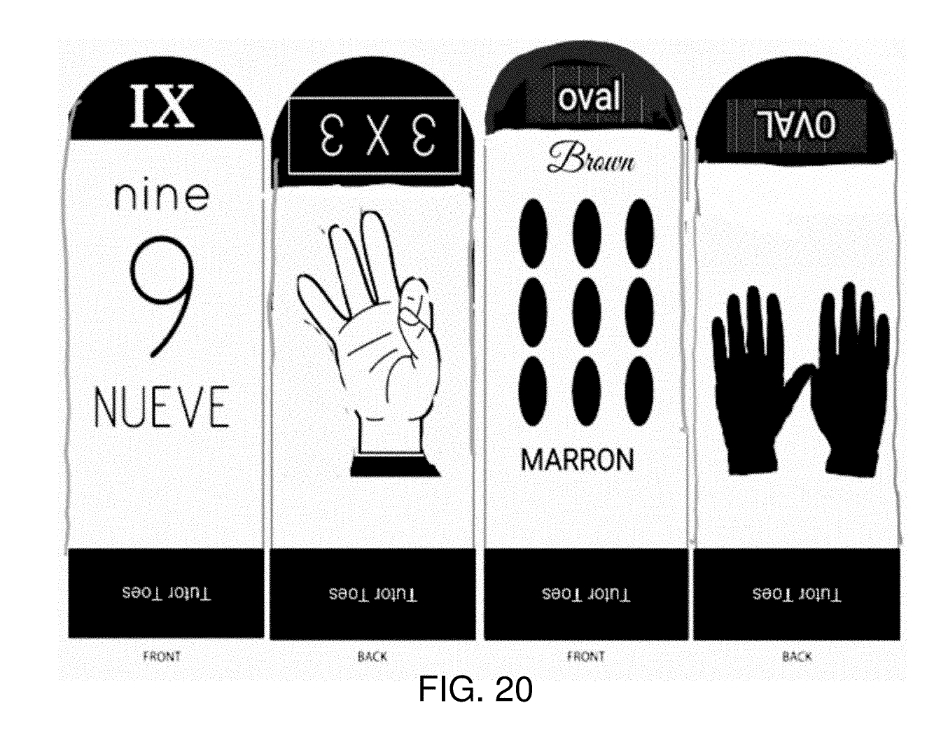

FIGS. 19 and 20 depict two possible variations of pairs of socks in certain embodiments of an elementary education learning system. Again, as in previous examples, the various topics, including the same side sock topic, the same sock topic, and the same sock pair topic become apparent, and the interplay between various symbols using the various characteristics of the symbols to demonstrate different relationships or topics is evident. For example, FIG. 19 shows different topics of the quantity 7, the color purple, and the shape of a rectangle, all expressed in various ways and taking advantage of different relations between different characteristics of the symbols disposed on the sock. FIG. 20 shows further examples of the various relations, topics, symbols and other elements described herein that are possible. Despite these specific, illustrative examples, the embodiments are not limited to the specific examples provided herein

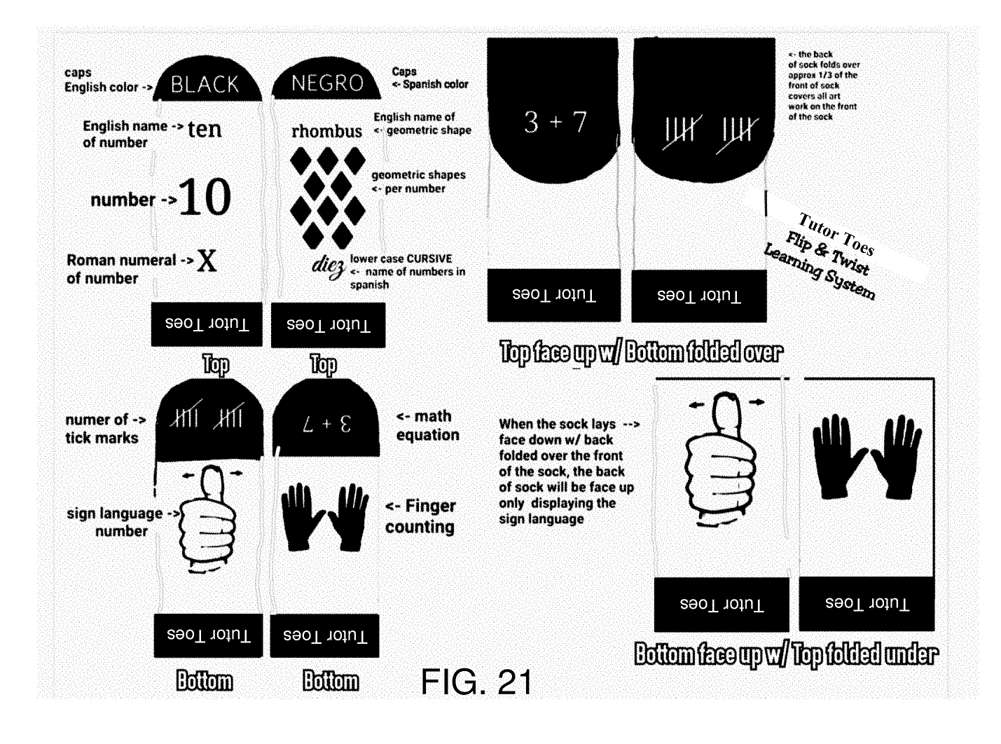

FIG. 21 depicts an embodiment similar to that of FIG. 16, but provides additional views depicting the bending or folding functionality discussed above. In particular, this figure shows how, in this particular embodiment, certain symbols would be visible on either side while the sock is folded, and certain symbols would be exposed from certain sides. This Figure also provides annotations showing and explaining the different symbols and how these symbols express the various topics as discussed herein, such as the same sock topic, the same side sock topic and the same sock pair topic.

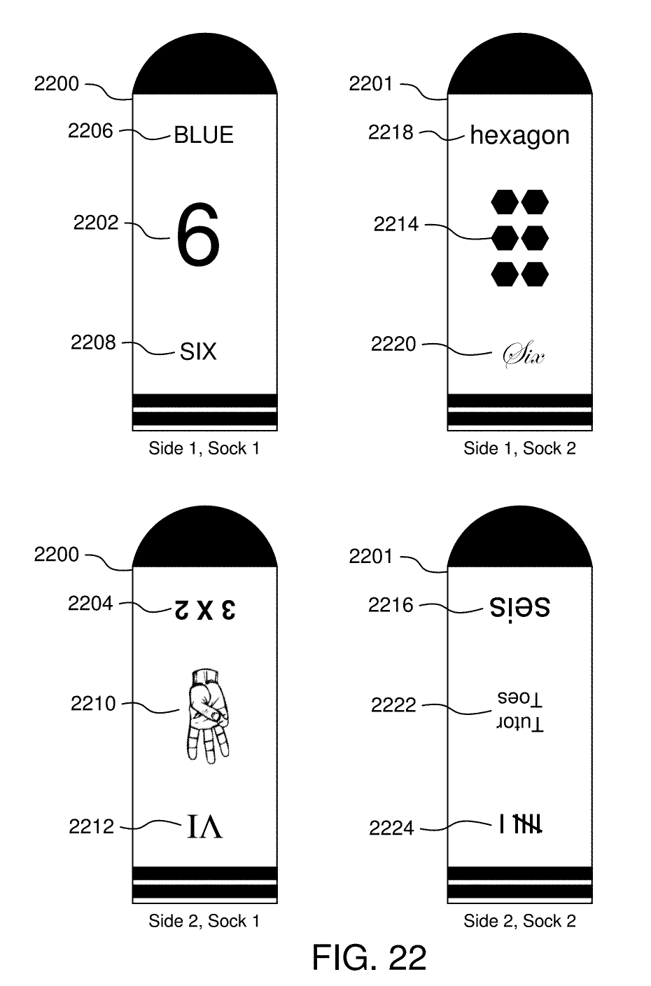

FIG. 22 depicts a schematic view of a first side and a second side of a pair of socks 2200, 2201 where the socks 2200, 2201 have sock symbols 2202-2224. The first sock 2200 includes a first sock symbol 2202 on a first side and includes a second sock symbol 2204 on the second side, as described above. In addition, the first side of the second sock 2201 includes a third sock symbol 2214 and the second side includes a fourth sock symbol 2216, as described above.

In the depicted embodiment, the first side of the first sock 2200 includes a fifth sock symbol 2206 located above the first sock symbol 2202 and a sixth sock symbol 2208 located below the first sock symbol 2202. The second side of the first sock 2200 includes a seventh sock symbol 2210 and an eighth sock symbol 2212 located below the second sock symbol 2204 where all three sock symbols 2204, 2210, 2212 are oriented with a top toward an opening of the first sock 2200.

Similarly, the first side of the second sock 2201 includes a ninth sock symbol 2218 located above the third sock symbol 2214 and a tenth sock symbol 2220 located below the third sock symbol 2214. The second side of the second sock 2201 includes an eleventh sock symbol 2222 and a twelfth sock symbol 2224 located below the fourth sock symbol 2216 where all three sock symbols 2216, 2222, 2224 are oriented with a top toward an opening of the second sock 2201.

The first sock symbol 2202, the second sock symbol 2204, the third sock symbol 2214, the fourth sock symbol 2216, the sixth sock symbol 2208, the seventh sock symbol 2210, the eighth sock symbol 2212, the tenth sock symbol 2220 and the twelfth sock symbol 2224 are all related to the same sock topic and/or sock pair topic of “six.” The first sock symbol 2202 is related to learning numbers, the second sock symbol 2204 is related to learning math, the third sock symbol 2214 is related to learning to recognize shapes and counting objects, the fourth sock symbol 2216 is related to learning a different language, the sixth sock symbol 2208 is related to learning spelling of numbers, the seventh sock symbol 2210 is related to learning sign language (the seventh sock symbol 2210 is the sign language symbol for six), the eighth sock symbol 2212 is related to learning Roman numerals, the tenth sock symbol 2220 is related to learning cursive writing and the twelfth sock symbol 2224 is related to counting using lines.

The fifth sock symbol 2206 is related to a different sock topic, which is the color “blue,” which may be a sock color for the closed end and bands near the open end at the bottom. The ninth sock symbol 2218 is related to learning how to read and matching a name of a shape with the shapes of the third sock symbol 2214. By having six of the hexagons of the third sock symbol 2214, the third sock symbol 2214 is related to two sock topics. The eleventh sock symbol 2222 is related to learning to read. Overall, the first sock 2200 and the second sock 2201 are related to many different types of learning appropriate for primary school children. Note that the learning types, sock symbols 2202-2224, sock topics, sock pair topics, etc. are interchangeable. Other pairs of socks will have different sock symbols and sock topics and/or sock pair topics and may or may not have different learning types.

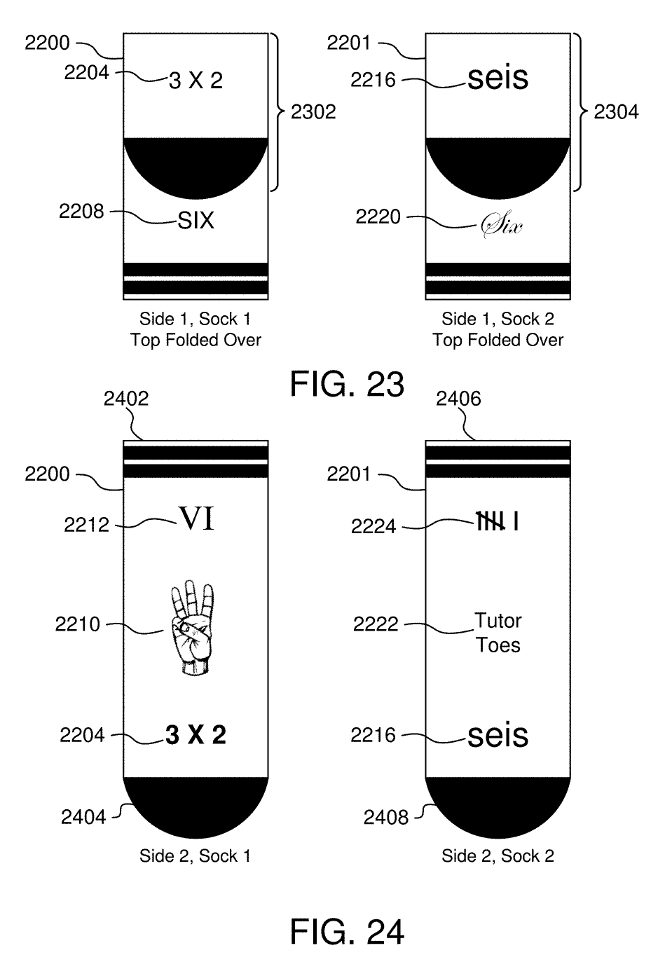

FIG. 23 depicts a schematic view of the socks 2200, 2201 of FIG. 22 with a top folded over. The first side of the first sock 2200 is depicted with a top portion 2302 of the first sock 2200 folded over to expose the second symbol 2204. Note that the sixth sock symbol 2208 is related to the second sock symbol 2204 so that a user can learn that 3×2 equals 6. In another embodiment, the top portion 2302 of the first sock 2200 is folded over more to cover the sixth sock symbol 2208 so a user must guess at the answer for 3×2. A person folding the first sock 2200 could expose the sixth sock symbol 2208 after a guess or fold the top portion 2302 of the first sock 2200 up to expose all three sock symbols 2202, 2206, 2208.

Likewise, the first side of the second sock 2201 is depicted with a top portion 2304 of the second sock 2201 folded over to expose the fourth symbol 2216. Note that the tenth sock symbol 2220 is related to the fourth sock symbol 2216 so that a user can learn that “seis” is six in a different language. In another embodiment, the top portion 2304 of the second sock 2201 is folded over more to cover the tenth sock symbol 2220 so a user must guess at the meaning of “seis.” A person folding the second sock 2201 could expose the tenth sock symbol 2220 after a guess or fold the top portion 2304 of the second sock 2201 up to expose all three sock symbols 2214, 2218, 2220.

Another use for the socks 2200, 2201 is to fold the sock 2201 to expose sock symbols on both sides of the socks 2200, 2201, which may be useful determine which learning principles to practice, to select socks 2200, 2201 for wearing, etc. FIG. 24 depicts a schematic view of the socks 2200, 2201 of FIG. 22 with the socks 2200, 2201 inverted prior to folding. The first sock 2200 and second sock 2201 are inverted so that the sock symbols 2204, 2210, 2212, 2216, 2222, 2224 are oriented top-side up. The first sock 2200 has an open end 2402 and a closed end 2404 and the second sock 2201 has an open end 2406 and a closed end 2408.

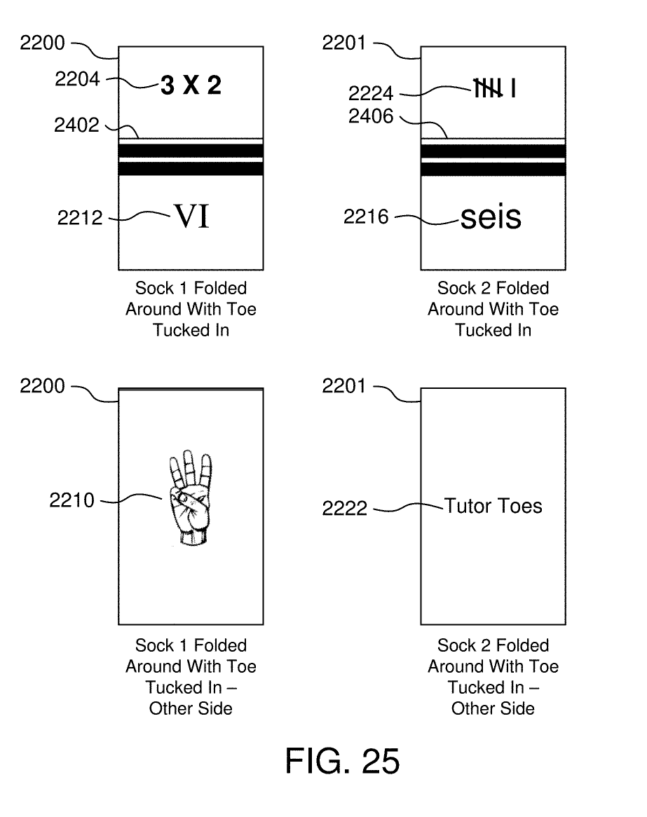

FIG. 25 depicts a schematic view of the socks 2200, 2201 of FIG. 22 with the closed end of the socks 2200, 2201 folded into the open end 2402, 2404 of the socks 2200, 2201. The top left diagram is of the first sock 2200 where the open end 2402 is visible. The closed end 2404 of the first sock 2200 is tucked into the open end 2402. The second sock symbol 2204 and the eighth sock symbol 2212 are exposed. The bottom left diagram includes the other side of the first sock 2200 where the seventh sock symbol 2210 is visible. The top right diagram is of the second sock 2201 where the open end 2406 is visible. The closed end 2408 of the second sock 2201 is tucked into the open end 2406. The twelfth sock symbol 2224 and the fourth sock symbol 2216 are exposed. The bottom right diagram includes the other side of the second sock 2201 where the eleventh sock symbol 2222 is visible.

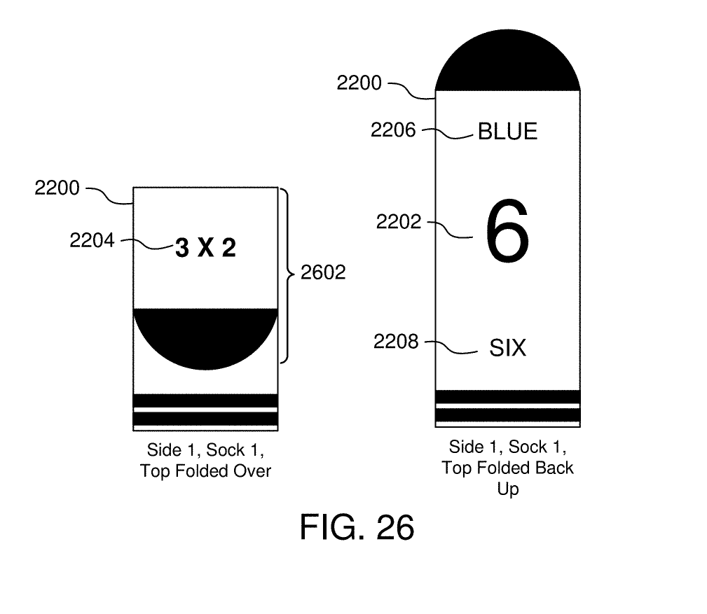

FIG. 26 depicts a schematic view of the first sock 2200 of FIG. 22 with a top folded over and with the top folded back up. In the diagram to the left, the first side of the first sock 2200 is visible and a top portion 2602 of the first sock 2200 is folded over to expose the second sock symbol 2204, which is “3×2.” In the embodiment, the top portion 2602 is folded so that all of the sock symbols 2202, 2206, 2208 of the first side are not visible. A user can guess at the answer to 3×2. A person can then fold up the top portion 2602 to expose the sock symbols 2202, 2206, 2208 of the first side of the first sock 2200 and both the first sock symbol 2202 and the sixth sock symbol 2208 are related to the sock topic of “six” so the user can be informed if the guess was correct or not. In some embodiments, each sock of a group of socks includes different sock symbols and may also include different sock topics. Thus, a user can learn many principles using the socks.

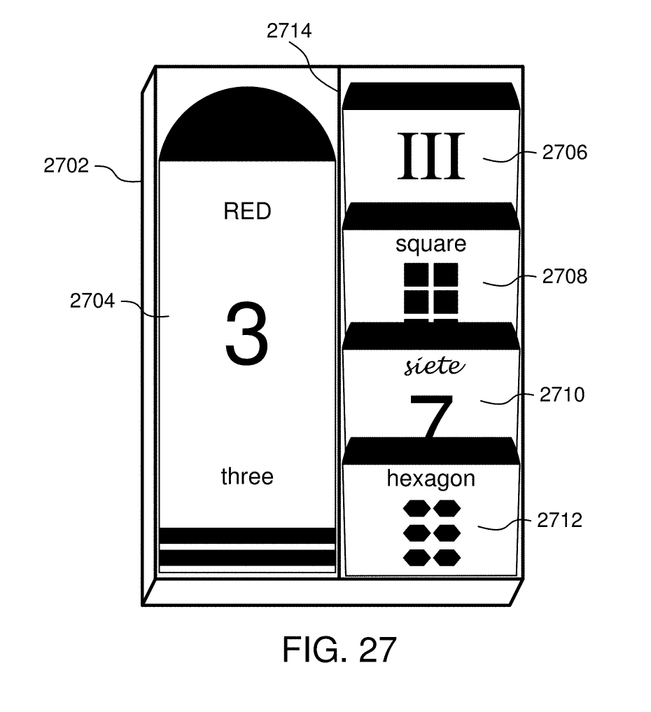

FIG. 27 depicts a schematic view of a display box 2702 with socks 2704 laid out lengthwise on one side and with folded socks 2706, 2708, 2710, 2712 in the other side. For example, the folded socks 2706, 2708, 2710, 2712 are folded with a closed end of each sock folded into the open end of each sock, as depicted in FIG. 25. While one sock 2704 is depicted on the left side of the box 2702, in other embodiments socks are stacked. The box 2702, in one embodiment, is configured to display the socks 2704, 2706, 2708, 2710, 2712 prior to a sale and is foldable into the box 2702. In some embodiments, the box 2702 includes a divider 2714. In some embodiments, socks (e.g. 2704) are laid out unfolded on both sides of the box 2702. In other embodiments, folded socks (e.g. 2706, 2708, 2710, 2712) are placed on both sides of the box 2702. The box 2702 is useful to store socks 2704, 2706, 2708, 2710, 2712 and also to display sock symbols to better provide a choice to a user for which sock(s) to use for learning. One of skill in the art will recognize other uses for the box 2702.

It can be seen that in the present invention provides for education of youngsters and others who may be learning to read, learning arithmetic, other mathematical functions, geography, different languages, textual citations, telling time, shapes, or any of a multitude of other principles. Furthermore, those doing laundry may find children more willing and happy to help because matching socks has become a game.

The present invention may be embodied in other specific forms without departing from its spirit or essential characteristics. The described embodiments are to be considered in all respects only as illustrative and not restrictive. Some other embodiments, though not specifically described herein, may comprise other combinations of elements described herein throughout the various illustrative embodiments. The scope of the invention is, therefore, indicated by the appended claims rather than by the foregoing description. All changes which come within the meaning and range of equivalency of the claims are to be embraced within their scope.

What is claimed is:

1. An apparatus for educating children, comprising:
a sock comprising an open end and a closed end distal to the open end, a first side and a second side opposite the first side, the first side and the second side disposed between the open end and the closed end;
a first sock symbol comprising a top and a bottom, the first sock symbol located on the first side of the sock and oriented with the top of the first sock symbol oriented toward the closed end of the sock;
a second sock symbol comprising a top and a bottom, the second sock symbol located on the second side of the sock toward the closed end of the sock and oriented with the bottom of the second sock symbol toward the closed end of the sock;
wherein bending an end of the sock toward the first side at a location below the second sock symbol inverts the second sock symbol and places the second sock symbol and a portion of the second side in a position to be viewed from the first side of the sock, and
wherein the first sock symbol differs from the second sock symbol and wherein the first sock symbol and the second sock symbol are related to a same sock topic.

2. The apparatus of claim 1, wherein the sock comprises a first sock and further comprising:
a second sock comprising an open end and a closed end distal to the open end, a first side and a second side opposite the first side, the first side and the second side disposed between the open end and the closed end;
a third sock symbol comprising a top and a bottom, the third sock symbol located on the first side of the second sock and oriented with the top of the third sock symbol oriented toward the closed end of the second sock;
a fourth sock symbol comprising a top and a bottom, the fourth sock symbol located on the second side of the second sock toward the closed end of the second sock and oriented with the bottom of the fourth sock symbol toward the closed end of the second sock;
wherein bending an end of the second sock toward the first side at a location below the fourth sock symbol inverts the fourth sock symbol and places the fourth sock symbol and a portion of the second side in a position to be viewed from the first side of the second sock, and
wherein the third sock symbol differs from the fourth sock symbol and wherein the third sock symbol and the fourth sock symbol are related to a same sock topic, and
wherein one or more of the first and second sock symbols of the first sock are related to one or more of the third and fourth sock symbols of the second sock through a same sock pair topic.

3. The apparatus of claim 2, wherein the first sock symbol, the second sock symbol, the third sock symbol and the fourth sock symbol comprise one or more of an alphanumeric character, a word, punctuation, a mathematical symbol, a mathematical equation, a shape, a color and text.

4. The apparatus of claim 2, wherein the same sock topic common to the first sock symbol and the second sock symbol, the same sock topic common to the third sock symbol and the fourth sock symbol and the same sock pair topic related to the first and second sock symbols of the first sock and the third and fourth sock symbols of the second sock comprise one or more of a mathematical topic, a phonetic topic, a language learning topic, a foreign language learning topic, a geography topic, a sign language topic, a geometric topic, a history topic, a science topic and a literary topic.

5. The apparatus of claim 2, further comprising a plurality of pairs of socks, wherein each pair of socks of the plurality of pairs of socks comprises a first sock with first and second sock symbols and a second sock with third and fourth sock symbols, wherein the same sock topics and the same sock pair topics of each pair of socks differs from the same sock topics and same sock pair topic of other pairs of socks in the plurality of pairs of socks.

6. The apparatus of claim 5, wherein the plurality of pairs of socks form a sock matching game, wherein each pair of socks comprises a unique same sock pair topic and a user matches a first sock with a second sock of a pair of socks of the plurality of pairs of socks according to the same sock pair topic of the pair of socks, and wherein the user matches each of the plurality of pairs of socks of the plurality of pairs of socks based on the same sock pair topic of the plurality of pairs of socks.

7. The apparatus of claim 1, wherein the first side of the sock comprises one or more additional sock symbols in addition to the first sock symbol, wherein the additional sock symbols are related the first sock symbol by a same side sock topic.

8. The apparatus of claim 1, wherein the second side of the sock comprises one or more additional sock symbols in addition to the second sock symbol, wherein the additional sock symbols are related the second sock symbol by a same side sock topic.

9. The apparatus of claim 1, wherein the sock forms a sock puppet, wherein a hand of a user inserted into the sock with a palm of the hand facing the first side of the sock bends the fingers of the user's hand to fold the second sock symbol over to be visible on the first side of the sock.

10. The apparatus of claim 1, wherein one or more of the first sock symbol, the second sock symbol, and any additional sock symbols comprise a non-skid material.

11. The apparatus of claim 1, wherein one or more of the first sock symbol, the second sock symbol, and any additional sock symbols comprise at least one of:
an image printed on the sock;
an iron-on transfer applied to the sock; and
a clothing patch applied to the sock.

12. The apparatus of claim 1, wherein bending an end of the sock toward the first side covers the first sock symbol and any additional sock symbols on the first side of the sock and exposes the second sock symbol in a same orientation as the first sock symbol.

13. The apparatus of claim 1, wherein one or more of:
the first side comprises the first sock symbol and two additional sock symbols below the first sock symbol toward the open end and oriented the same as the first sock symbol; and
the second side comprises two additional symbols below the second sock symbol toward the open end and oriented the same as the second sock symbol,
wherein bending the closed end to insert into the open end exposes one sock symbol on one side of the folded sock and two symbols on the other side of the folded sock, each adjacent to where the closed end is tucked into the open end.

14. The apparatus of claim 1, further comprising additional socks, each sock comprising sock symbols and further comprising a box configured with a divider forming two compartments in the box, wherein each compartment is sized with a length to accommodate a sock without folding the sock and a depth to accommodate a plurality of stacked socks and each compartment is sized to accommodate a plurality of socks folded with the closed end of the sock tucked into the open end of the sock.

15. A memory game apparatus for educating children, comprising
a first sock and a second sock, each comprising an open end and a closed end distal to the open end, a first side and a second side opposite the first side;
a first sock symbol located on the first side of the first sock and oriented with a top of the first sock symbol oriented toward the closed end of the first sock;
a second sock symbol located on the second side of the first sock toward the closed end of the first sock and oriented with a bottom of the second sock symbol toward the closed end of the first sock;
a third sock symbol located on the first side of the second sock and oriented with a top of the third sock symbol oriented toward the closed end of the second sock;
a fourth sock symbol located on the second side of the second sock toward the closed end of the second sock and oriented with a bottom of the fourth sock symbol toward the closed end of the second sock;
wherein bending an end of the first sock toward the first side at a location below the second sock symbol inverts the second sock symbol and places the second sock symbol and a portion of the second side in a position to be viewed from the first side of the first sock,
wherein bending an end of the second sock toward the first side at a location below the fourth sock symbol inverts the fourth sock symbol and places the fourth sock symbol and a portion of the second side in a position to be viewed from the first side of the second sock,
wherein the first sock symbol differs from the second sock symbol and wherein the first sock symbol and the second sock symbol are related to a same sock topic;
wherein the third sock symbol differs from the fourth sock symbol and wherein the third sock symbol and the fourth sock symbol are related to a same sock topic, and
wherein one or more of the first and second sock symbols of the first sock are related to one or more of the third and fourth sock symbols of the second sock through a same sock pair topic.

16. The apparatus of claim 15, wherein one or more of the first sock and the second sock comprise one or more additional sock symbols, wherein the additional sock symbols are related to a sock topic.

17. The apparatus of claim 15, wherein each sock side comprises three sock symbols spaced apart from the closed end to the open end and the sock symbols on the first side of a sock are each oriented with a top of the sock symbol toward the closed end of the sock and the sock symbols of the second side of the sock are each oriented with a bottom toward the closed end of the sock.

18. The apparatus of claim 17, wherein bending the first sock exposes the second sock symbol while covering at least one of the sock symbols of the first side of the first sock, wherein the second sock symbol is oriented in a same orientation as the sock symbols on the first side of the first sock and wherein bending the second sock exposes the fourth sock symbol while covering at least one of the sock symbols of the first side of the second sock, wherein the fourth sock symbol is oriented in a same orientation as the sock symbols on the first side of the second sock.

19. An apparatus for educating children, comprising:
a first sock and a second sock, each comprising an open end and a closed end distal to the open end, a first side and a second side opposite the first side;
a first sock symbol located on the first side of the first sock and oriented with a top of the first sock symbol oriented toward the closed end of the first sock;
a second sock symbol located on the second side of the first sock toward the closed end of the first sock and oriented with a bottom of the second sock symbol toward the closed end of the first sock;
a third sock symbol located on the first side of the second sock and oriented with a top of the third sock symbol oriented toward the closed end of the second sock;
a fourth sock symbol located on the second side of the second sock toward the closed end of the second sock and oriented with a bottom of the fourth sock symbol toward the closed end of the second sock;
a fifth sock symbol and a sixth sock symbol each located above or below the first sock symbol;
a seventh sock symbol and an eighth sock symbol each located above or below the second sock symbol;
a ninth sock symbol and a tenth sock symbol each located below the third sock symbol toward the open end of the second sock on the first side; and
an eleventh sock symbol and a twelfth sock symbol each located below the fourth sock symbol toward the open end of the second sock on the second side,
wherein the sock symbols on a side are stacked vertically.

20. The apparatus of claim 19, wherein each sock symbol on the first side of the first and second socks are oriented with a top toward the closed end and each sock symbol on the second side of the first and second socks are oriented with a bottom toward the closed end, wherein:
each of the sock symbols are different;
at least one sock symbol on a first side of the first sock and at least one sock symbol on the second side of the first sock are related to a same sock topic;
at least one sock symbol on a first side of the second sock and at least one sock symbol on the second side of the second sock are related to a same sock topic; and
at least one sock symbol on the first sock and a sock symbol on the second sock are related to a sock pair topic.
